(19) United States
(12) Patent Application Publication
(10) Pub. No.: US 2017/0192203 A1
(43) Pub. Date: Jul. 6, 2017

(54) Imaging Zoom Lens

(71) Applicant: Tan Cian Technology Co., Ltd., Taichung City (TW)

(72) Inventor: Shih-Yuan Chang, Jhubei City (TW)

(21) Appl. No.: 15/174,287

(22) Filed: Jun. 6, 2016

(30) Foreign Application Priority Data
Dec. 30, 2015 (TW) 104144372

(51) Int. Cl. G02B 13/00; G02B 27/00; G02B 15/16

(52) U.S. Cl. CPC G02B 13/009; G02B 15/16; G02B 27/0025; G02B 5/208

(57) ABSTRACT

An imaging zoom lens includes a first lens group, a second lens group and a third lens group in sequence along an optical axis of the imaging zoom lens. With the structural relationship of the first to third lens group and relevant optical parameters, the imaging zoom lens may be as miniaturized as possible while maintaining good optical performance.

### CROSS-REFERENCE TO RELATED APPLICATION

This application claims priority to Taiwanese Patent Application No. 104144372, filed on Dec. 30, 2015.

### FIELD

The disclosure relates to an imaging zoom lens, and more particularly to an imaging zoom lens used for a portable electronic device.

### BACKGROUND

In recent years, as portable electronic devices such as mobile phones and digital cameras become ubiquitous, much effort has been put into reducing dimensions of such portable electronic devices. Moreover, as dimensions of charge-coupled device (CCD) and complementary metal-oxide-semiconductor (CMOS) based optical sensors are reduced, dimensions of imaging zoom lenses for use with the optical sensors must be correspondingly reduced without significantly compromising optical performance. Imaging quality and size are two of the most important characteristics for an imaging zoom lens.

However, in optical lens design, simply reducing proportionally a size of an imaging zoom lens does not enable the imaging zoom lens to maintain its imaging quality. In the design process, material properties and assembly yield of the imaging zoom lens should also be considered.

Therefore, miniaturized imaging zoom lens encounters greater technical difficulties than traditional imaging zoom lenses. Producing an imaging zoom lens that meets the requirements of portable electronic products while having satisfactory optical performance is always a goal in the industry.

### SUMMARY

An object of the disclosure is to provide an imaging zoom lens to be as miniaturized as possible while maintaining good optical performance.

According to the disclosure, an imaging zoom lens includes a first lens group, a second lens group and a third lens group in sequence from an object side to an image side along an optical axis of the imaging zoom lens. The first lens group has a positive effective focal length and an aperture stop. The second lens group has a positive effective focal length. The third lens group has a negative effective focal length. The imaging zoom lens satisfies:

1.31<f1/fw<2.87;

0.62<f2/fw<1.06;

0.45<|f3|/fw<1.00;

1.33<TTLw/ImagH<4.00; and

1.50<ft/fw<5.00,

where f1 represents the effective focal length of the first lens group, f2 represents the effective focal length of the second lens group, f3 represents the effective focal length of the third lens group, TTLw represents a total lens length of the imaging zoom lens at a wide angle end on the optical axis, ImagH represents a maximum image height of the imaging zoom lens on an image plane of the imaging zoom lens, ft represents a system focal length of the imaging zoom lens at a telephoto end on the optical axis, and fw represents a system focal length of the imaging zoom lens at the wide angle end.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram that illustrates an imaging zoom lens of a first embodiment according to the disclosure at a wide angle end;

FIG. 2 is a schematic diagram that illustrates the imaging zoom lens of the first embodiment at a telephoto end;

FIG. 3 shows values of some optical data corresponding to the imaging zoom lens of the first embodiment;

FIG. 4 shows values of some conic constants and aspherical coefficients corresponding to the imaging zoom lens of the first embodiment;

FIGS. 5(A) to 5(D) show different optical characteristics of the imaging zoom lens of the first embodiment at the wide angle end;

FIGS. 5(E) to 5(H) show different optical characteristics of the imaging zoom lens of the first embodiment at an intermediate position between the wide angle and telephoto ends;

FIGS. 5(I) to 5(L) show different optical characteristics of the imaging zoom lens of the first embodiment at the telephoto end;

FIG. 6 is a schematic diagram that illustrates an imaging zoom lens of a second embodiment according to the disclosure at a wide angle end;

FIG. 7 is a schematic diagram that illustrates the imaging zoom lens of the second embodiment at a telephoto end;

FIG. 8 shows values of some optical data corresponding to the imaging zoom lens of the second embodiment;

FIG. 9 shows values of some conic constants and aspherical coefficients corresponding to the imaging zoom lens of the second embodiment;

FIGS. 10(A) to 10(D) show different optical characteristics of the imaging zoom lens of the second embodiment at the wide angle end;

FIGS. 10(E) to 10(H) show different optical characteristics of the imaging zoom lens of the second embodiment at an intermediate position between the wide angle and telephoto ends;

FIGS. 10(I) to 10(L) show different optical characteristics of the imaging zoom lens of the second embodiment at the telephoto end;

FIG. 11 is a schematic diagram that illustrates an imaging zoom lens of a third embodiment according to the disclosure at a wide angle end;

FIG. 12 is a schematic diagram that illustrates the imaging zoom lens of the third embodiment at a telephoto end;

FIG. 13 shows values of some optical data corresponding to the imaging zoom lens of the third embodiment;

FIG. 14 shows values of some conic constants and aspherical coefficients corresponding to the imaging zoom lens of the third embodiment;

FIGS. 15(A) to 15(D) show different optical characteristics of the imaging zoom lens of the third embodiment at the wide angle end;

FIGS. 15(E) to 15(H) show different optical characteristics of the imaging zoom lens of the third embodiment at an intermediate position between the wide angle and telephoto ends;

FIGS. 15(I) to 15(L) show different optical characteristics of the imaging zoom lens of the third embodiment at the telephoto end;

FIG. 16 is a schematic diagram that illustrates an imaging zoom lens of a fourth embodiment according to the disclosure at a wide angle end;

FIG. 17 is a schematic diagram that illustrates the imaging zoom lens of the fourth embodiment at a telephoto end;

FIG. 18 shows values of some optical data corresponding to the imaging zoom lens of the fourth embodiment;

FIG. 19 shows values of some conic constants and aspherical coefficients corresponding to the imaging zoom lens of the fourth embodiment;

FIGS. 20(A) to 20(D) show different optical characteristics of the imaging zoom lens of the fourth embodiment at the wide angle end;

FIGS. 20(E) to 20(H) show different optical characteristics of the imaging zoom lens of the fourth embodiment at an intermediate position between the wide angle and telephoto ends;

FIGS. 20(I) to 20(L) show different optical characteristics of the imaging zoom lens of the fourth embodiment at the telephoto end;

FIG. 21 is a schematic diagram that illustrates an imaging zoom lens of a fifth embodiment according to the disclosure at a wide angle end;

FIG. 22 is a schematic diagram that illustrates the imaging zoom lens of the fifth embodiment at a telephoto end;

FIG. 23 shows values of some optical data corresponding to the imaging zoom lens of the fifth embodiment;

FIG. 24 shows values of some conic constants and aspherical coefficients corresponding to the imaging zoom lens of the fifth embodiment;

FIGS. 25(A) to 25(D) show different optical characteristics of the imaging zoom lens of the fifth embodiment at the wide angle end;

FIGS. 25(E) to 25(H) show different optical characteristics of the imaging zoom lens of the fifth embodiment at an intermediate position between the wide angle and telephoto ends;

FIGS. 25(I) to 25(L) show different optical characteristics of the imaging zoom lens of the fifth embodiment at the telephoto end;

FIG. 26 is a schematic diagram that illustrates an imaging zoom lens of a sixth embodiment according to the disclosure at a wide angle end;

FIG. 27 is a schematic diagram that illustrates the imaging zoom lens of the sixth embodiment at a telephoto end;

FIG. 28 shows values of some optical data corresponding to the imaging zoom lens of the sixth embodiment;

FIG. 29 shows values of some conic constants and aspherical coefficients corresponding to the imaging zoom lens of the sixth embodiment;

FIGS. 30(A) to 30(D) show different optical characteristics of the imaging zoom lens of the sixth embodiment at the wide angle end;

FIGS. 30(E) to 30(H) show different optical characteristics of the imaging zoom lens of the sixth embodiment at an intermediate position between the wide angle and telephoto ends;

FIGS. 30(I) to 30(L) show different optical characteristics of the imaging zoom lens of the sixth embodiment at the telephoto end;

FIG. 31 is a schematic diagram that illustrates an imaging zoom lens of a seventh embodiment according to the disclosure at a wide angle end;

FIG. 32 is a schematic diagram that illustrates the imaging zoom lens of the seventh embodiment at a telephoto end;

FIG. 33 shows values of some optical data corresponding to the imaging zoom lens of the seventh embodiment;

FIG. 34 shows values of some conic constants and aspherical coefficients corresponding to the imaging zoom lens of the seventh embodiment;

FIGS. 35(A) to 35(D) show different optical characteristics of the imaging zoom lens of the seventh embodiment at the wide angle end;

FIGS. 35(E) to 35(H) show different optical characteristics of the imaging zoom lens of the seventh embodiment at an intermediate position between the wide angle and telephoto ends;

FIGS. 35(I) to 35(L) show different optical characteristics of the imaging zoom lens of the seventh embodiment at the telephoto end; and

FIG. 36 is a table that lists values of relationships among some lens parameters corresponding to the imaging lenses of the first to seventh embodiments.

### DETAILED DESCRIPTION

Before the disclosure is described in greater detail, it should be noted that like elements are denoted by the same reference numerals throughout the disclosure.

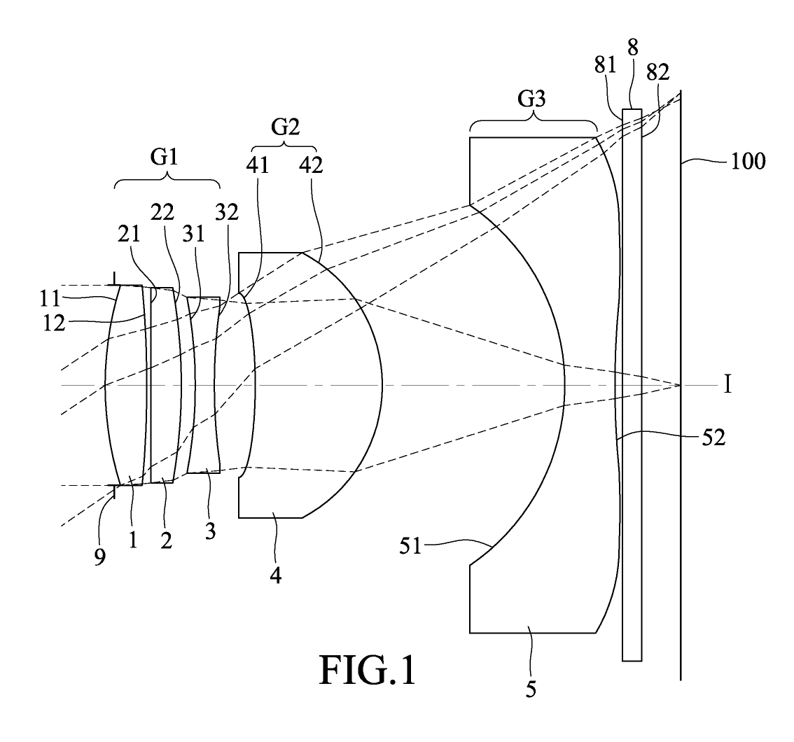

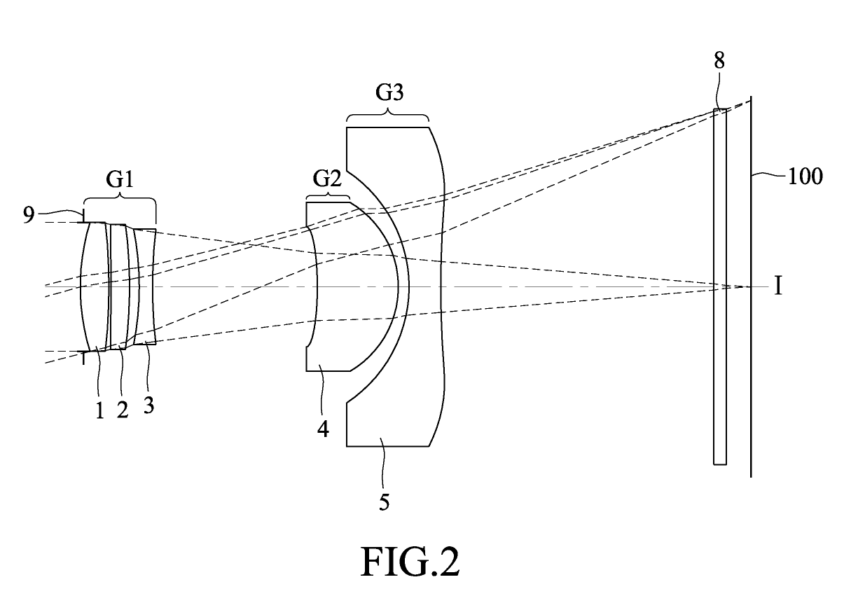

FIGS. 1 and 2 illustrate an imaging zoom lens of a first embodiment according to the present disclosure at a wide angle end and a telephoto end, respectively. The imaging zoom lens includes a first lens group (G1) having a positive effective focal length, a second lens group (G2) having a positive effective focal length, a third lens group (G3) having a negative effective focal length, and an optical filter 8. The first to third lens group (G1-G3) and the optical filter 8 are arranged in sequence from an object side to an image side along an optical axis (I) of the imaging zoom lens. The optical filter 8 is an infrared cut filter for selectively absorbing infrared light to thereby reduce imperfection of images formed at an image plane 100 of the imaging zoom lens. In further detail, the object side refers to the side of an object to be photographed, and the image side refers to the side of the image plane 100.

In this embodiment, the first lens group (G1) has an aperture stop 9 and includes first, second and third lens elements 1-3. The second lens group (G2) includes a fourth lens element 4. The third lens element (G3) includes a fifth lens element 5. The aperture stop 9 and the first to fifth lens elements 1-5 are arranged in sequence from the object side to the image side along the optical axis (I). Each of the first, second, third, fourth and fifth lens elements 1-5 and the optical filter 8 has an object-side surface 11, 21, 31, 41, 51, 81 facing toward the object side, and an image-side surface 12, 22, 32, 42, 52, 82 facing toward the image side. Light entering the imaging zoom lens travels through the aperture stop 9, the object-side and image-side surfaces 11, 12 of the first lens element 1, the object-side and image-side surfaces 21, 22 of the second lens element 2, the object-side and image-side surfaces 31, 32 of the third lens element 3, the object-side and image-side surfaces 41, 42 of the fourth lens element 4, the object-side and image-side surfaces 51, 52 of the fifth lens element 5, and the object-side and image-side surfaces 81, 82 of the optical filter 8 sequentially to form an image on the image plane 100. Each of the object-side surfaces 11, 21, 31, 41, 51 and the image-side surfaces 12, 22, 32, 42, 52 is aspherical and has a center point coinciding with the optical axis (I).

Each of the lens elements 1-5 is made of a plastic material in order to be lightweight. However, at least one of the lens elements 3-7 may be made of other materials in other embodiments.

The first lens element 1 has a positive refractive power, and the object-side and image-side surfaces 11, 12 of the first lens element 1 are convex surfaces respectively convex relative to the object and image sides. The second lens element 2 has a positive refractive power, and the object-side and image-side surfaces 21, 22 of the second lens element 2 are convex surfaces respectively convex relative to the object and image sides. The third lens element 3 has a negative refractive power, and the object-side and image-side surfaces 31, 32 of the third lens element 3 are concave surfaces respectively concave relative to the object and image sides. The fourth lens element 4 has a positive refractive power. The object-side surface 41 of the fourth lens element 4 is a concave surface concave relative to the object side, and the image-side surface 42 of the fourth lens element 4 is a convex surface convex relative to the image side. The fifth lens element 5 has a negative refractive power, and the object-side and image-side surfaces 51, 52 of the fifth lens element 5 are concave surfaces respectively concave relative to the object and image sides. In this embodiment, the imaging zoom lens does not include any lens element with a refractive power other than the first lens element 1, the second lens element 2, the third lens element 3, the fourth lens element 4 and the fifth lens element 5.

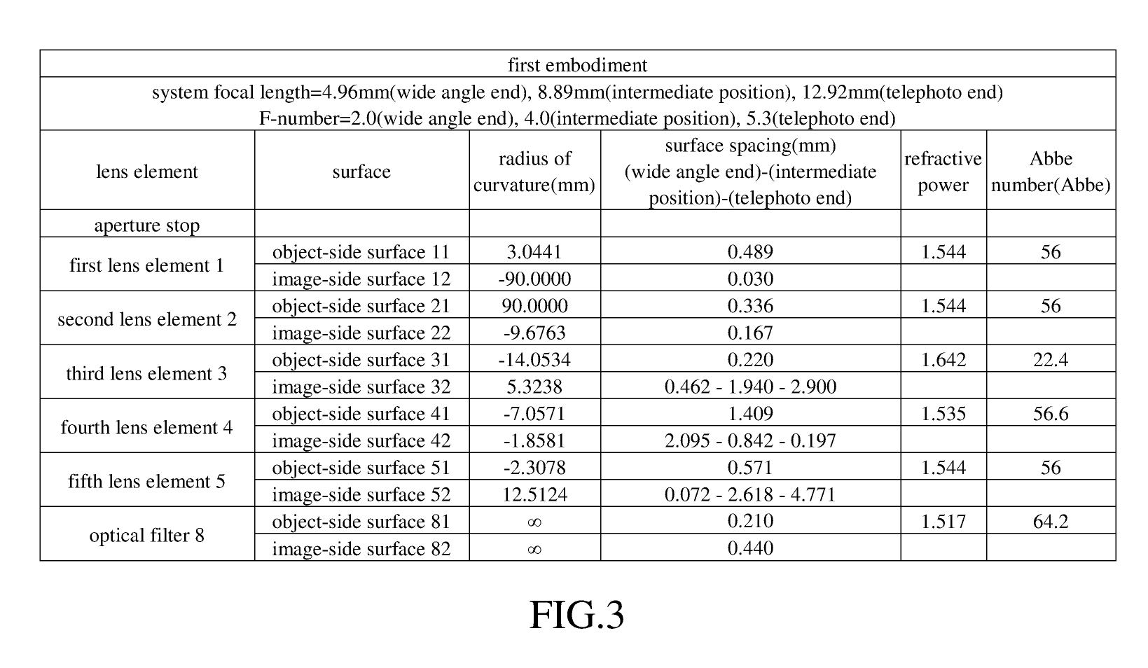

Shown in FIG. 3 is a table of the first embodiment that lists values of some optical data corresponding to the surfaces 11-51 and 81, 12-52 and 82 of the first to fifth lens elements 1-5 and the optical filter 8 when the imaging zoom lens is at the wide angle end, an intermediate position between the wide angle and telephoto ends, or the telephoto end.

In this embodiment, each of the object-side surfaces 11-51 and the image-side surfaces 12-52 is aspherical, and satisfies the relationship of

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {A}_{2 i} \times {Y}^{2 i} \qquad ( 1 )$$

where:

R represents a radius of curvature of an aspherical surface;

Z represents a depth of the aspherical surface, which is defined as a perpendicular distance between an arbitrary point on the aspherical surface that is spaced apart from the optical axis (I) by a distance Y, and a tangent plane at a vertex of the aspherical surface at the optical axis (I);

Y represents a perpendicular distance between the arbitrary point on the aspherical surface and the optical axis (I);

K represents a conic constant; and

A₂ᵢ represents a 2i^{th} aspherical coefficient.

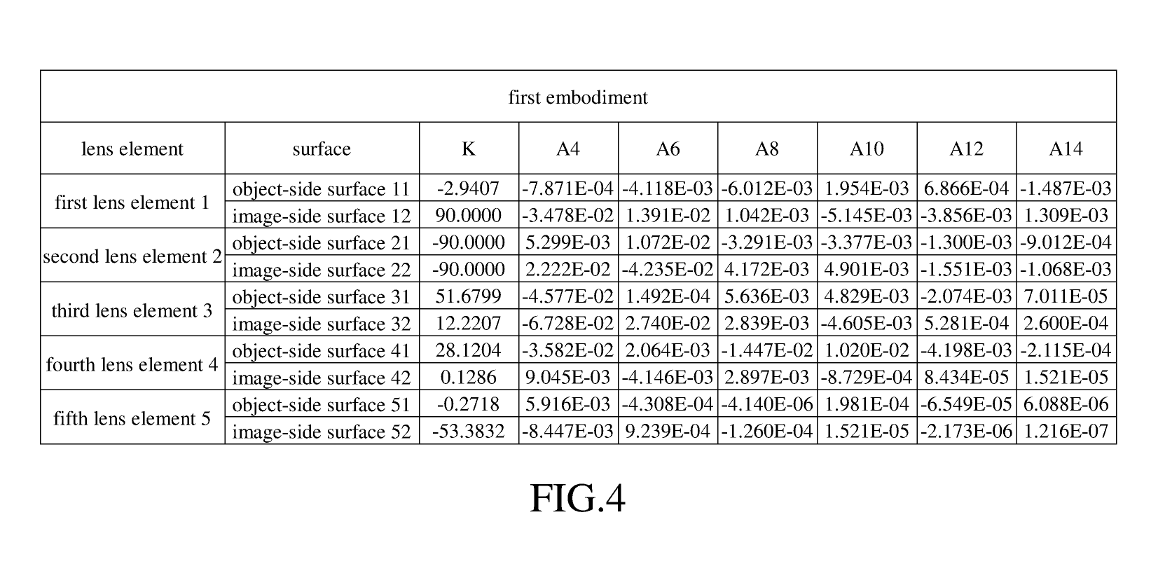

Shown in FIG. 4 is a table that lists values of some conic constants and aspherical coefficients of the aforementioned relationship (1) corresponding to the first embodiment.

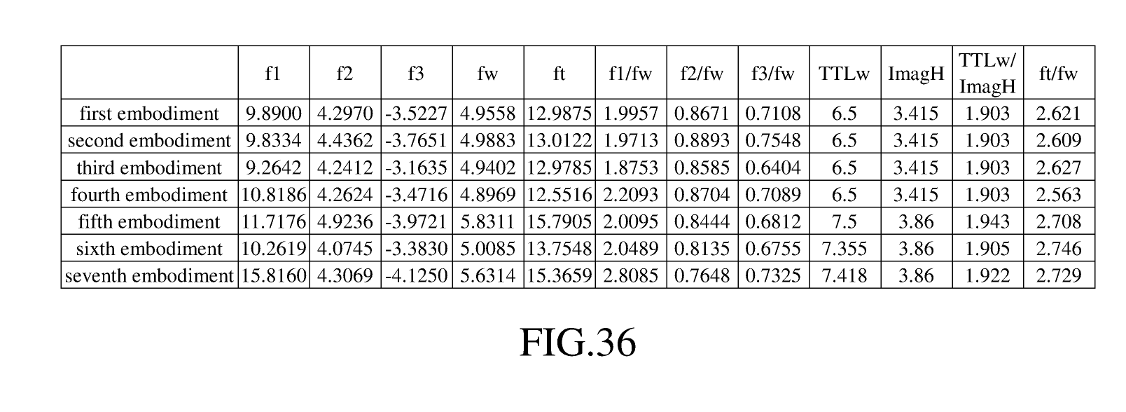

Relationships among some of the lens parameters corresponding to the first embodiment are listed in columns of FIG. 36 corresponding to the first embodiment. Note that some terminologies are defined as follows:

f1 represents the effective focal length of the first lens group (G1);

f2 represents the effective focal length of the second lens group (G2);

f3 represents the effective focal length of the third lens group (G3);

TTLw represents a total lens length of the imaging zoom lens at a wide angle end on the optical axis, i.e., a distance between the object-side surface 11 of the first lens element 1 and the image plane 100 of the imaging zoom lens at the wide angle end along the optical axis (I);

ImagH represents a maximum image height of the imaging zoom lens on the image plane 100;

ft represents the system focal length of the imaging zoom lens at the telephoto end on the optical axis (I); and

fw represents the system focal length of the imaging zoom lens at the wide angle end.

With reference back to FIGS. 1 and 2, when zooming from the wide angle end to the telephoto end, the distance between the first and second lens group (G1, G2) along the optical axis (I) is increased, the distance between the second and third lens group (G2, G3) along the optical axis (I) is reduced, and the distance between the third lens group (G3) and the object-side surface 81 of the optical filter 8 along the optical axis (I) is increased. In addition, since each of the first, second and third lens group (G1-G3) is movable along the optical axis (I) during zooming, the movement of the first, second and third lens group (G1-G3) may be reduced, thereby shortening time for zooming operation.

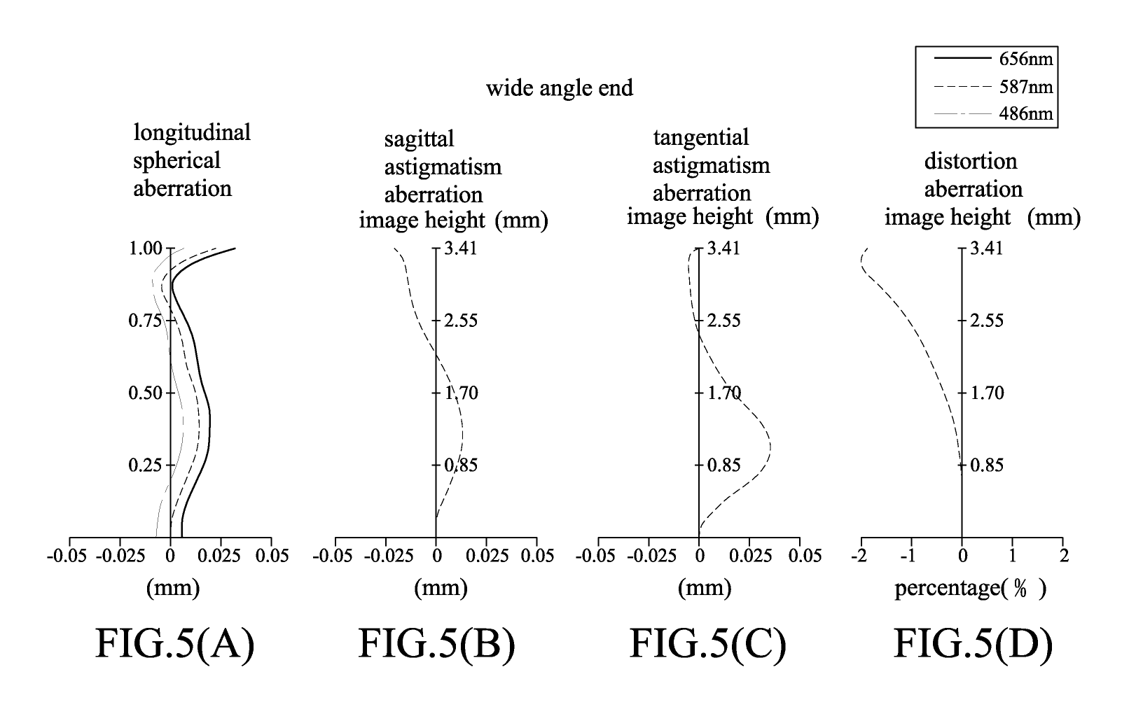

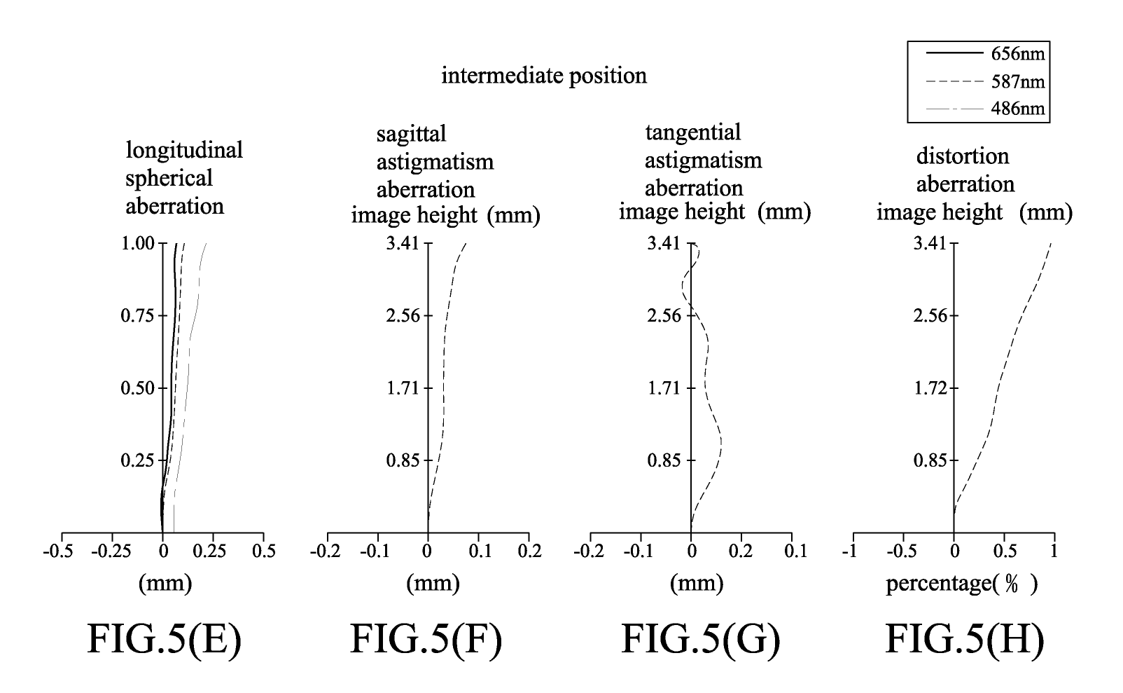

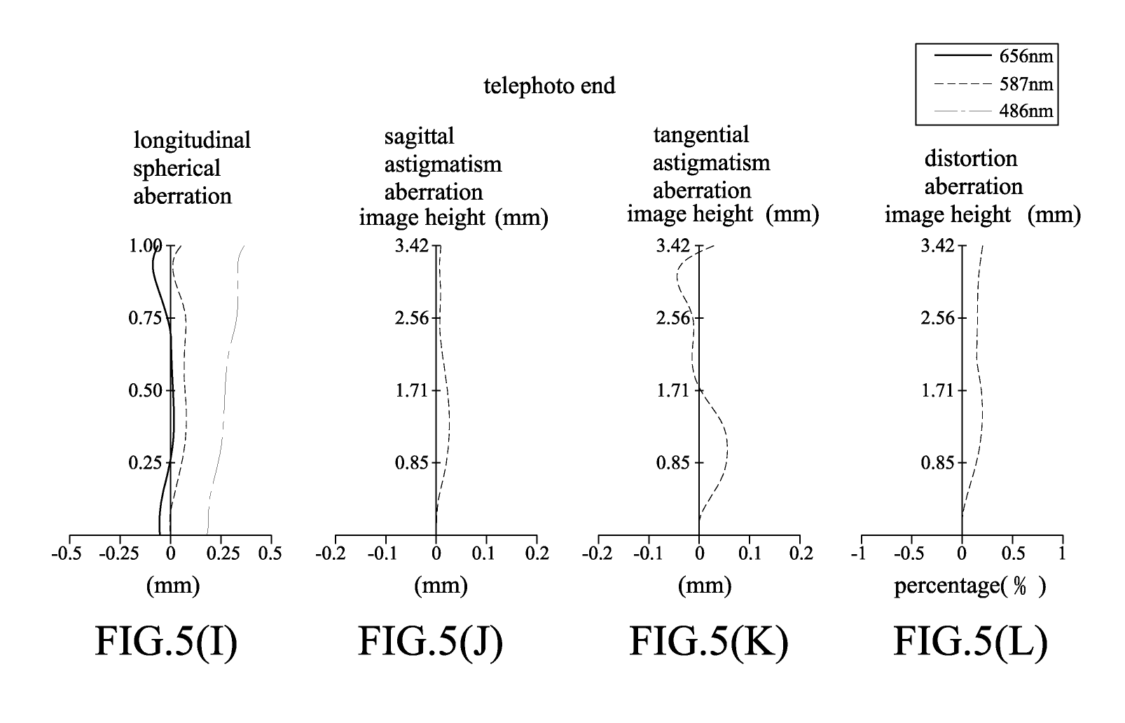

FIGS. 5(A) to 5(D) show simulation results at the wide angle end respectively corresponding to longitudinal spherical aberration, sagittal astigmatism aberration, tangential astigmatism aberration, and distortion aberration of the first embodiment. FIGS. 5(E) to 5(H) show simulation results at the intermediate position respectively corresponding to longitudinal spherical aberration, sagittal astigmatism aberration, tangential astigmatism aberration, and distortion aberration of the first embodiment. FIGS. 5(I) to 5(L) show simulation results at the telephoto end respectively corresponding to longitudinal spherical aberration, sagittal astigmatism aberration, tangential astigmatism aberration, and distortion aberration of the first embodiment.

It can be understood from FIGS. 5(A), 5(E) and 5(I) that, since variation of each of spherical aberration curves falls within the range of ±0.25 mm, the first embodiment is able to achieve a relatively low spherical aberration at different wavelengths.

Furthermore, since the curves at each of wavelengths of 486 nm, 587 nm, and 656 nm are close to each other, the first embodiment has a relatively low chromatic aberration.

It can be understood from FIGS. 5(B), 5(C), 5(F), 5(G), 5(J) and 5 (K) that, since each of astigmatic field curves falls within the range of ±0.1 mm, the first embodiment has a relatively low optical aberration.

Moreover, as shown in FIGS. 5(D), 5(H) and 5(L), since each of distortion curves falls within the range of ±2%, the first embodiment is able to meet requirements in imaging quality of most optical systems.

In view of the above, with proper corrections of the longitudinal spherical aberration, the sagittal astigmatism aberration, the tangential astigmatism aberration, and the distortion aberration, the imaging zoom lens of the first embodiment is able to achieve a relatively good optical performance. Therefore, the imaging zoom lens of the first embodiment can maintain relatively good optical performance while being miniaturized and lightweight.

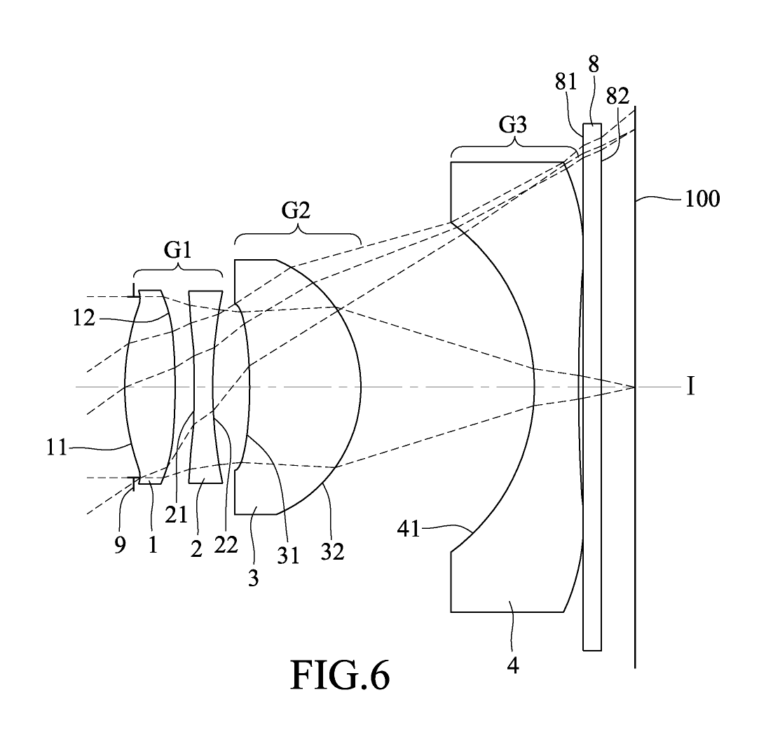

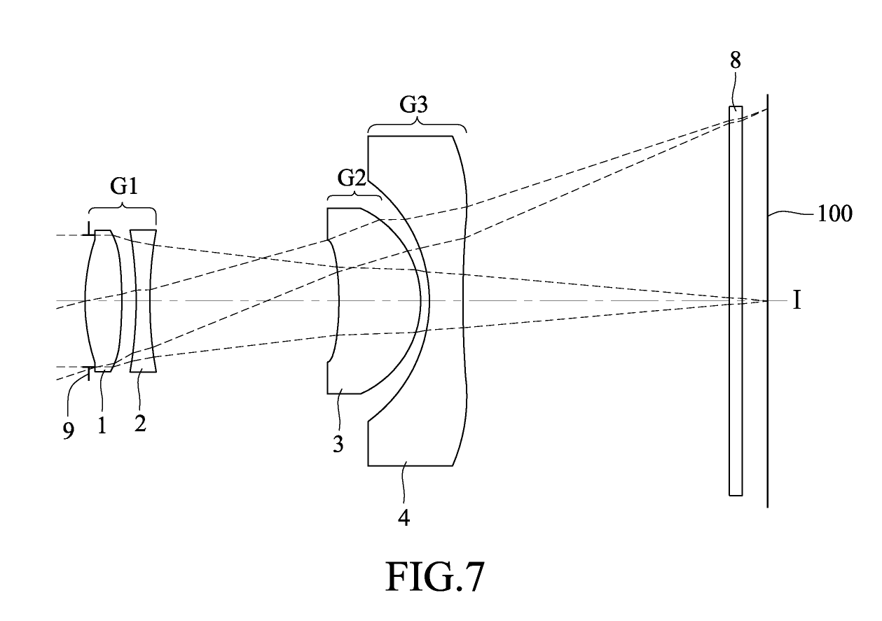

FIGS. 6 and 7 illustrate an imaging zoom lens of a second embodiment according to the present disclosure at a wide angle end and a telephoto end, respectively. The second embodiment has a configuration similar to that of the first embodiment, and differs from the first embodiment in some of the quantity, the optical data, the aspherical coefficients and the lens parameters of the lens elements of the lens groups (G1-G3). Furthermore, in the second embodiment, the first lens group (G1) has an aperture stop 9 and includes first and second lens elements 1-2. The second lens group (G2) includes a third lens element 3, and the third lens group (G3) includes a fourth lens element 4. The aperture stop 9 and the first to fourth lens elements 1-4 are arranged in sequence from the object side to the image side along the optical axis (I).

The first lens element 1 has a positive refractive power, and the object-side and image-side surfaces 11, 12 of the first lens element 1 are convex surfaces respectively convex relative to the object and image sides. The second lens element 2 has a negative refractive power, and the object-side and image-side surfaces 21, 22 of the second lens element 2 are concave surfaces respectively concave relative to the object and image sides. The third lens element 3 has a positive refractive power. The object-side surface 31 of the third lens element 3 is a concave surface concave relative to the object side, and the image-side surface 32 of the third lens element 3 is a convex surface convex relative to the image side. The fourth lens element 4 has a negative refractive power. The object-side and the image-side surfaces 41, 42 of the fourth lens element 4 are concave surfaces respectively concave relative to the object and image sides. In this embodiment, each of the object-side surfaces 11, 21, 31, 41 and the image-side surfaces 12, 22, 32, 42 is aspherical and has a center point coinciding with the optical axis (I), and the imaging zoom lens does not include any lens element with a refractive power other than the first lens element 1, the second lens element 2, the third lens element 3 and the fourth lens element 4.

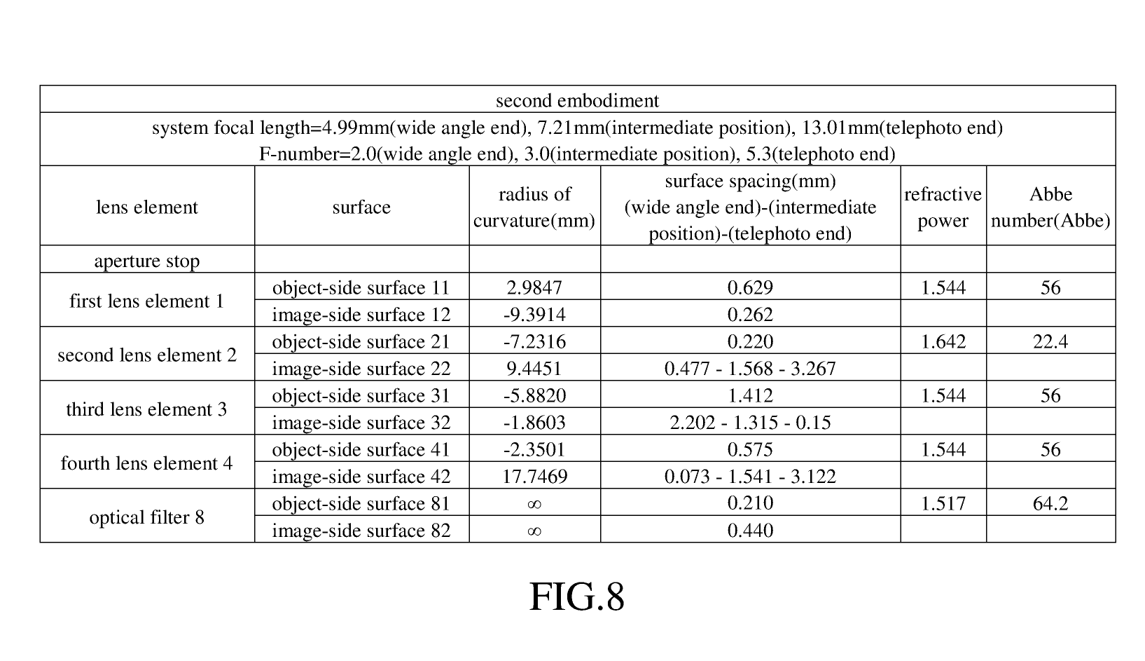

Shown in FIG. 8 is a table of the second embodiment that lists values of some optical data corresponding to the surfaces 11-41 and 81, 12-42 and 82 of the first to fourth lens elements 1-4 and the optical filter 8 when the imaging zoom lens is at the wide angle end, an intermediate position between the wide angle and telephoto ends, or the telephoto end.

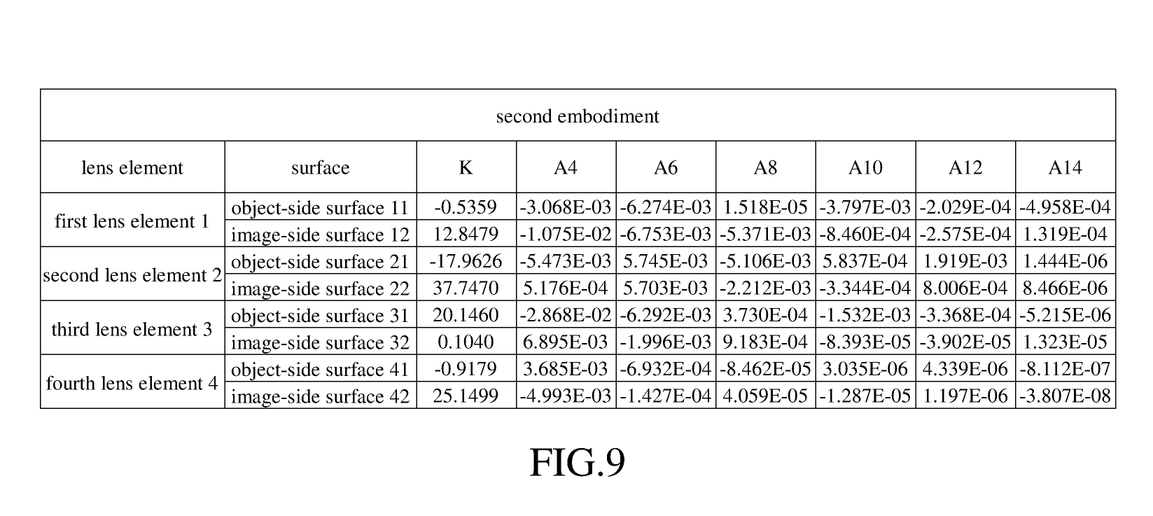

Shown in FIG. 9 is a table that lists values of some conic constants and aspherical coefficients of the aforementioned relationship (1) corresponding to the second embodiment.

Relationships among some of the aforementioned lens parameters corresponding to the second embodiment are listed in the columns of FIG. 36 corresponding to the second embodiment.

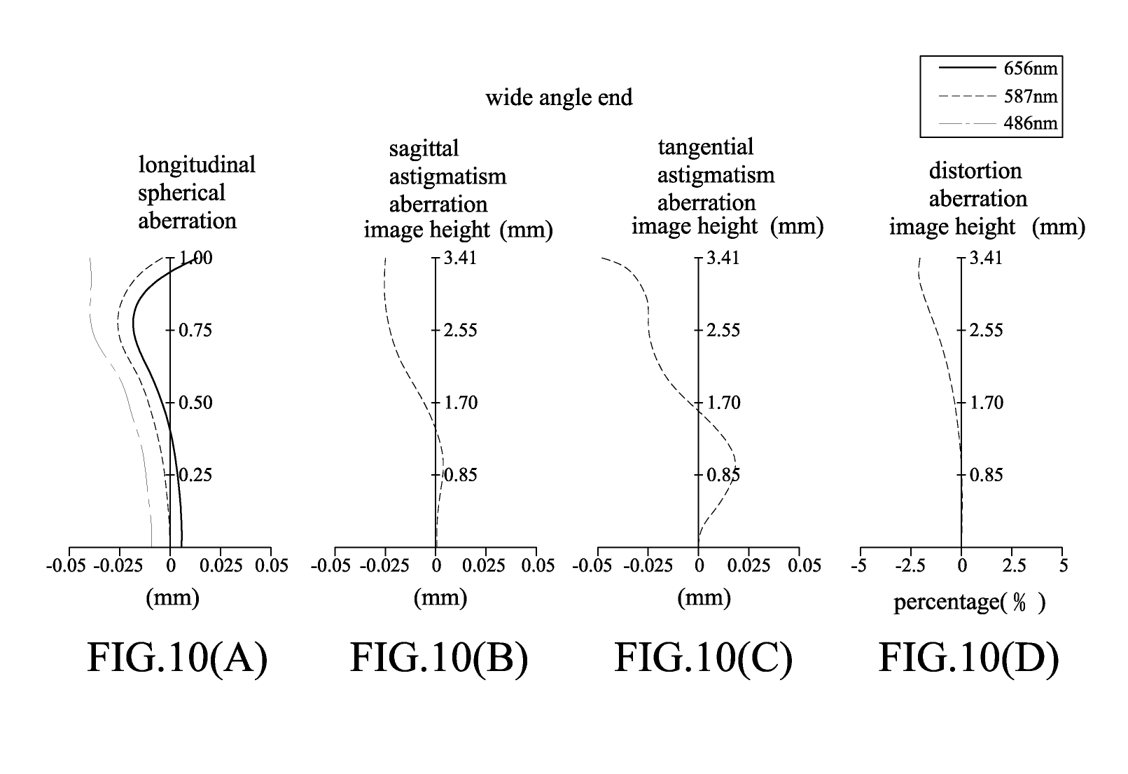

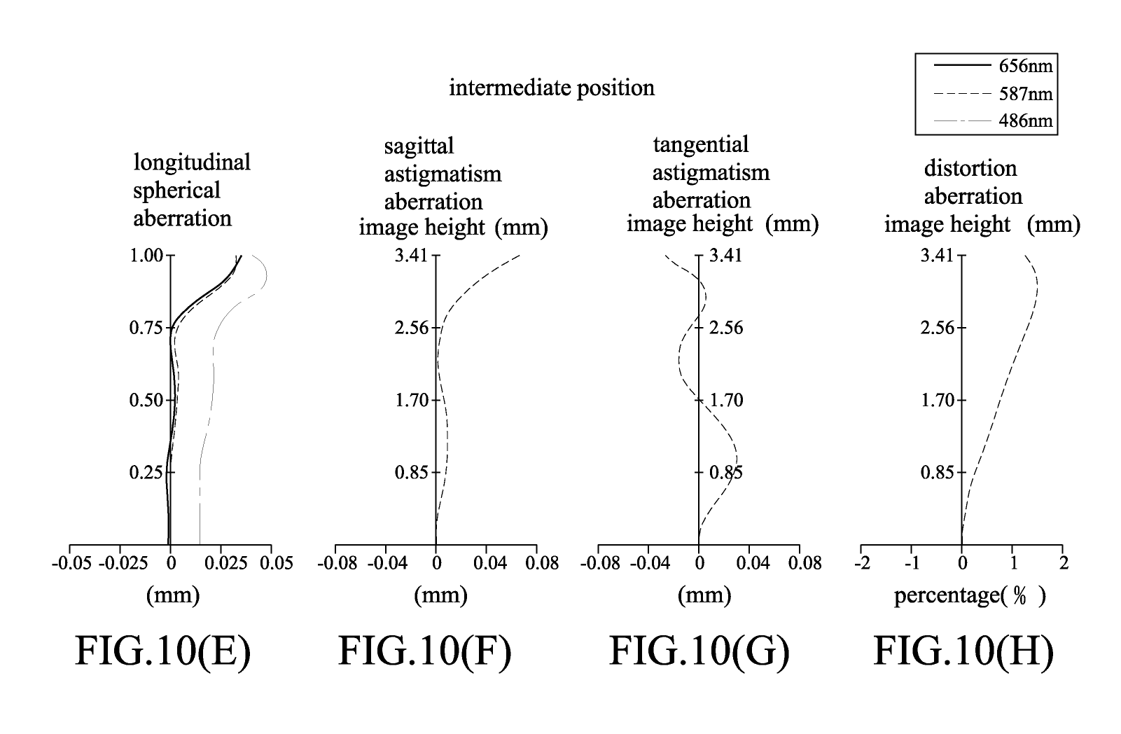

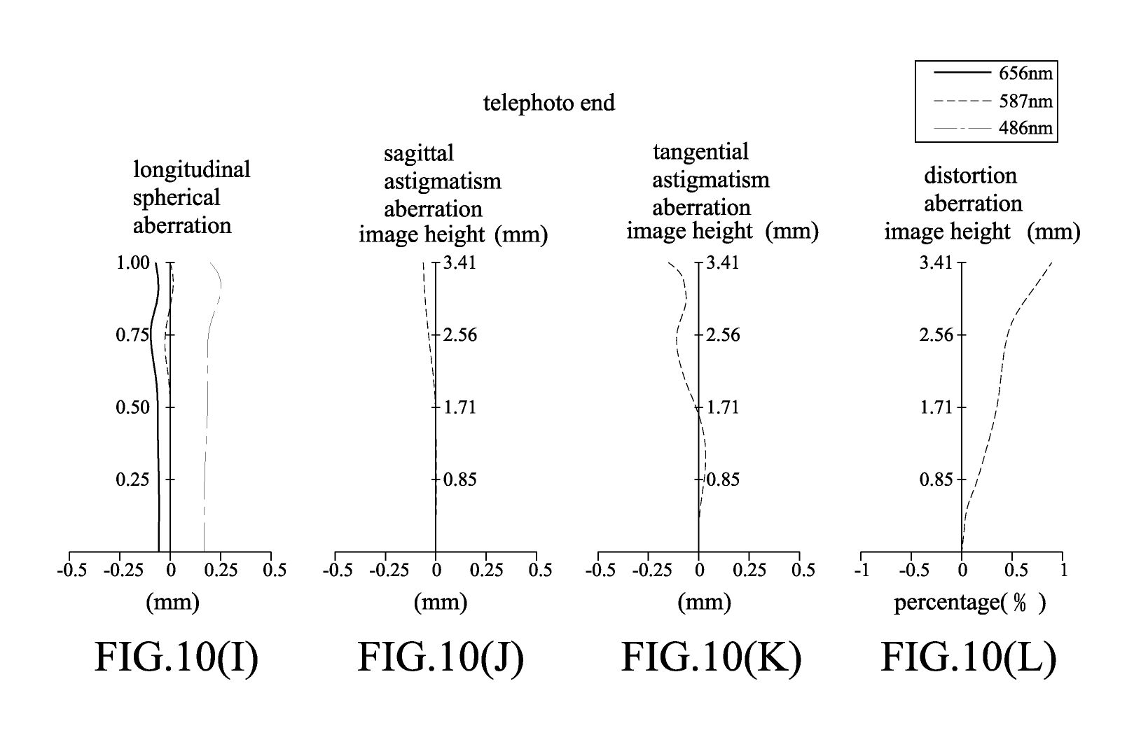

FIGS. 10(A) to 10(D) show simulation results at the wide angle end respectively corresponding to longitudinal spherical aberration, sagittal astigmatism aberration, tangential astigmatism aberration, and distortion aberration of the second embodiment. FIGS. 10(E) to 10(H) show simulation results at the intermediate position respectively corresponding to longitudinal spherical aberration, sagittal astigmatism aberration, tangential astigmatism aberration, and distortion aberration of the second embodiment. FIGS. 10(I) to 10(L) show simulation results at the telephoto end respectively corresponding to longitudinal spherical aberration, sagittal astigmatism aberration, tangential astigmatism aberration, and distortion aberration of the second embodiment. It can be understood from FIGS. 10(A) to 10(L) that the second embodiment is able to achieve a relatively good optical performance.

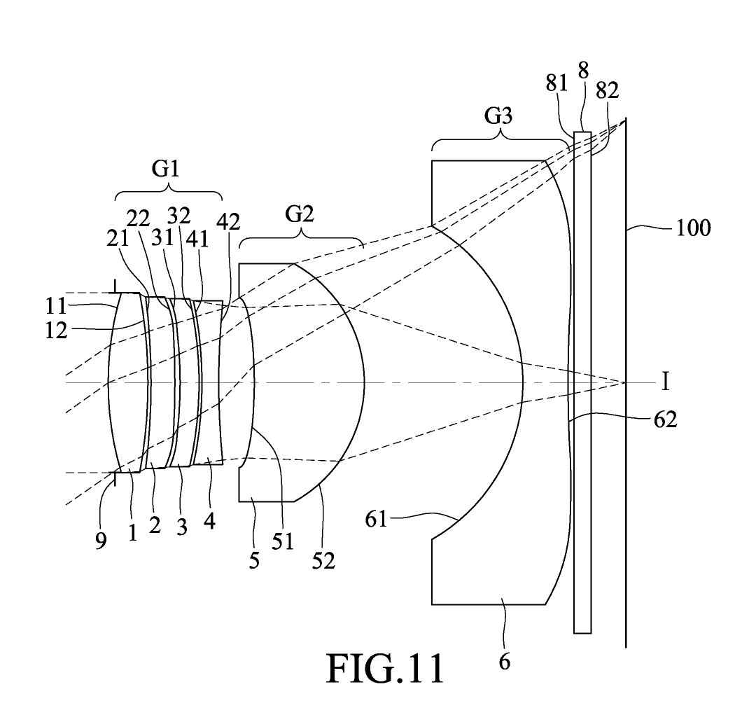

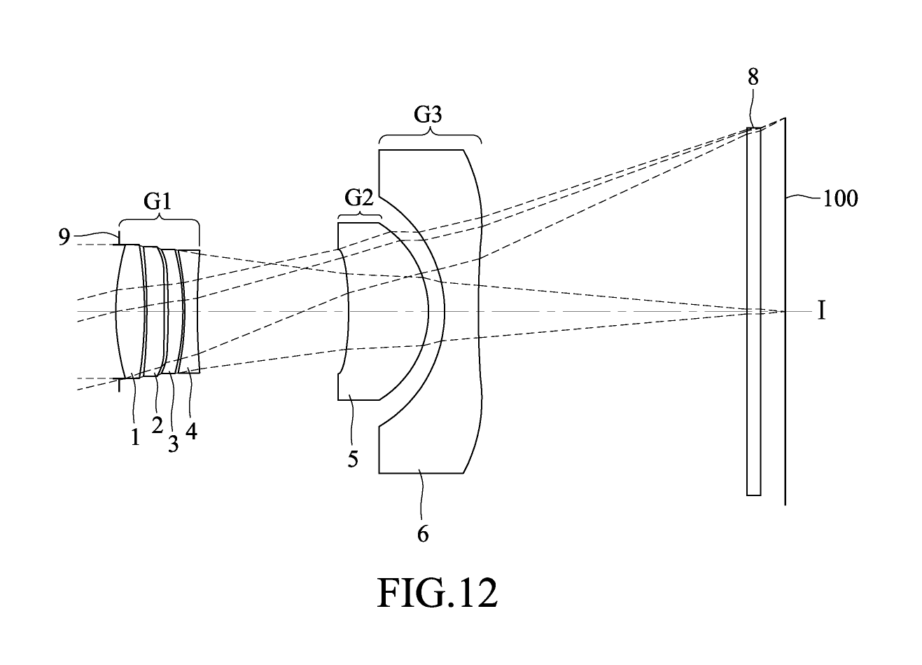

FIGS. 11 and 12 illustrates an imaging zoom lens of a third embodiment according to the present disclosure at a wide angle end and a telephoto end, respectively. The third embodiment has a configuration similar to that of the first embodiment, and differs from the first embodiment in some of the quantity, the optical data, the aspherical coefficients and the lens parameters of the lens elements of the lens groups (G1-G3). Furthermore, in the third embodiment, the first lens group (G1) has an aperture stop 9 and includes first, second, third and fourth lens elements 1-4. The second lens group (G2) includes a fifth lens element 5, and the third lens group (G3) includes a sixth lens element 6. The aperture stop 9 and the first to sixth lens elements 1-6 are arranged in sequence from the object side to the image side along the optical axis (I).

The first lens element 1 has a positive refractive power, and the object-side and image-side surfaces 11, 12 of the first lens element 1 are convex surfaces respectively convex relative to the object and image sides. The second lens element 2 has a negative refractive power, and the object-side and image-side surfaces 21, 22 of the second lens element 2 are concave surfaces respectively concave relative to the object and image sides. The third lens element 3 has a positive refractive power. The object-side and image-side surfaces 31, 32 of the third lens element 3 are convex surfaces respectively convex relative to the object and image sides. The fourth lens element 4 has a negative refractive power. The object-side surface 41 of the fourth lens element 4 is a concave surface concave relative to the object side and the image-side surface 42 of the fourth lens element 4 is a convex surface convex relative to the image side. The fifth lens element 5 has a positive refractive power. The object-side surface 51 of the fifth lens element 5 is a concave surface concave relative to the object side, and the image-side surface 52 of the fifth lens element 5 is a convex surface convex relative to the image side. The sixth lens element 6 has a negative refractive power, and the object-side and image-side surfaces 61, 62 of the sixth lens element 6 are concave surfaces respectively concave relative to the object and image sides. In this embodiment, each of the object-side surfaces 11, 21, 31, 41, 51, 61 and the image-side surfaces 12, 22, 32, 42. 52, 62 is aspherical and has a center point coinciding with the optical axis (I), and the imaging zoom lens does not include any lens element with a refractive power other than the first lens element 1, the second lens element 2, the third lens element 3, the fourth lens element 4, the fifth lens element 5 and the sixth lens element 6.

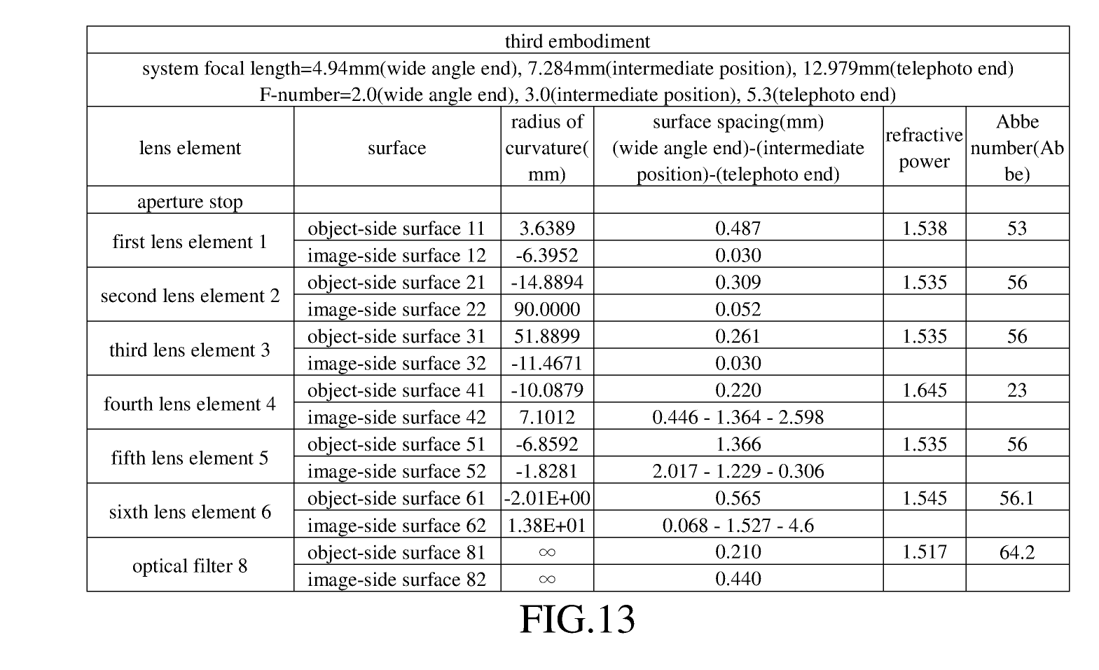

Shown in FIG. 13 is a table of the third embodiment that lists values of some optical data corresponding to the surfaces 11-61 and 81, 12-62 and 82 of the first to sixth lens elements 1-6 and the optical filter 8 when the imaging zoom lens is at the wide angle end, an intermediate position between the wide angle and telephoto ends, or the telephoto end.

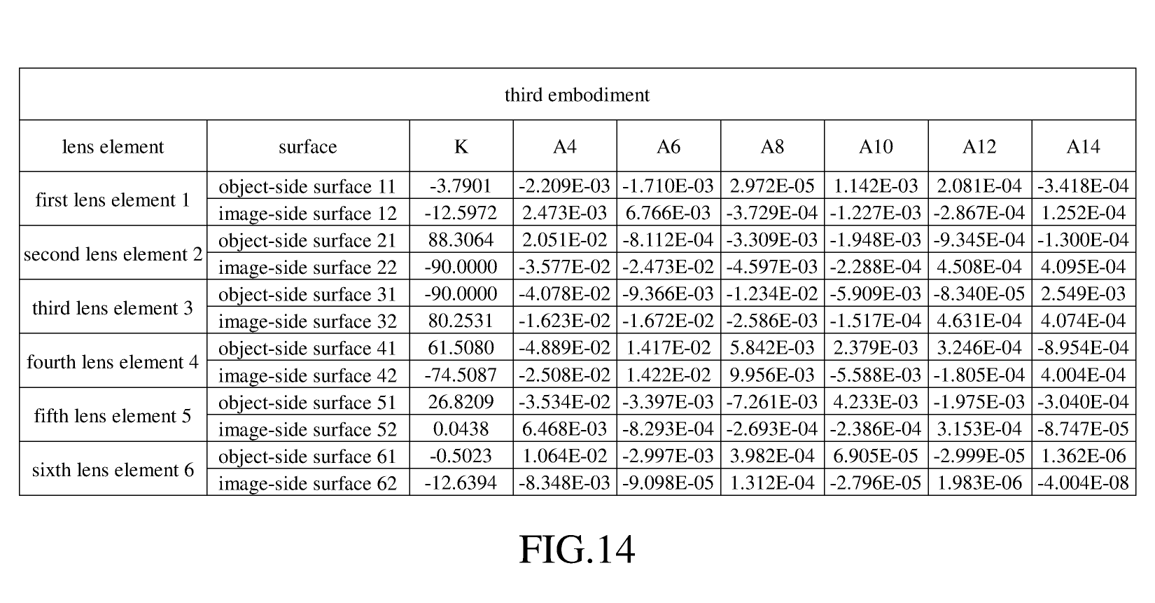

Shown in FIG. 14 is a table that lists values of some conic constants and aspherical coefficients of the aforementioned relationship (1) corresponding to the third embodiment.

Relationships among some of the aforementioned lens parameters corresponding to the third embodiment are listed in the columns of FIG. 36 corresponding to the third embodiment.

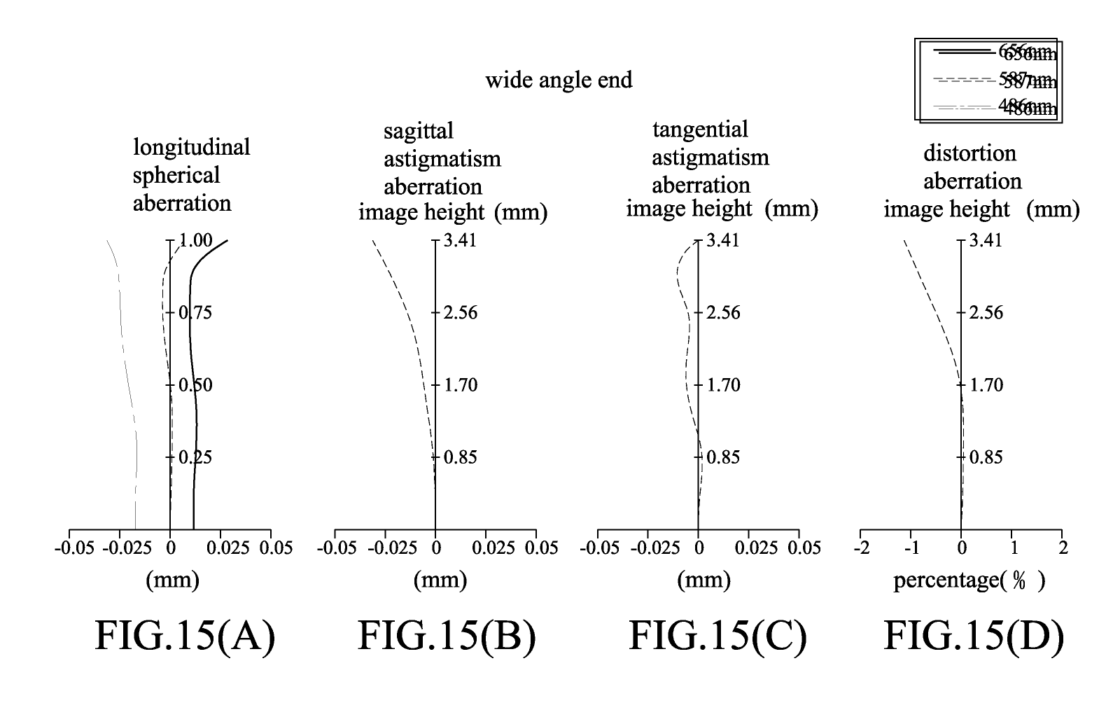

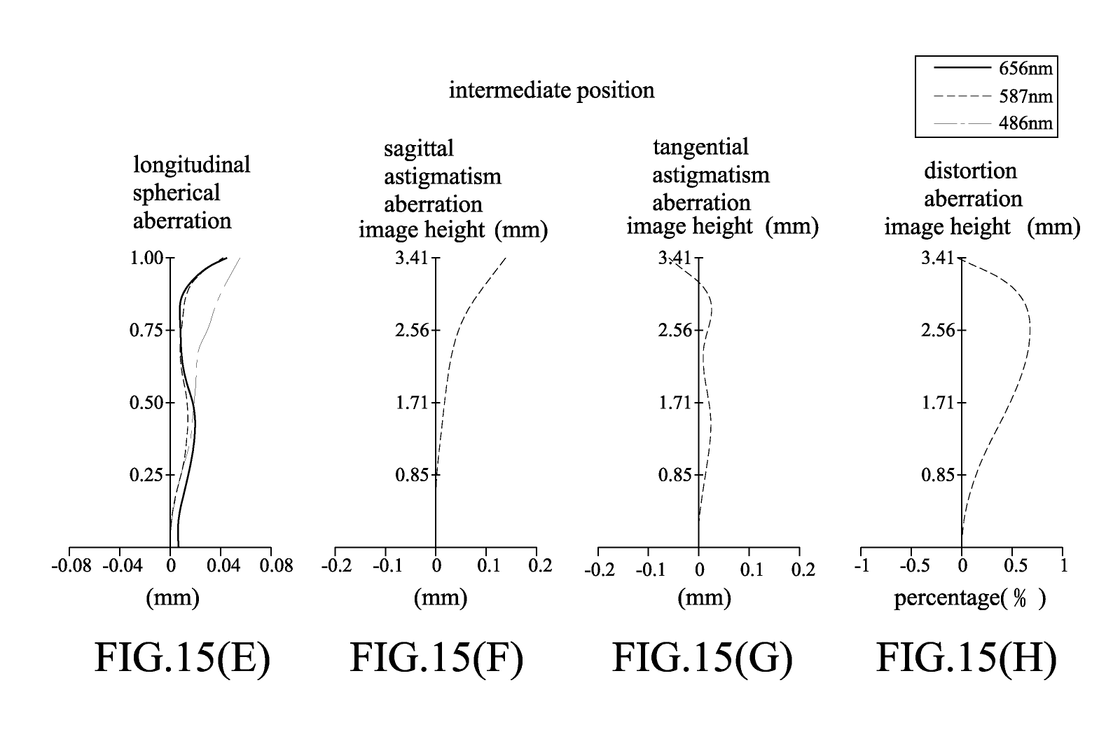

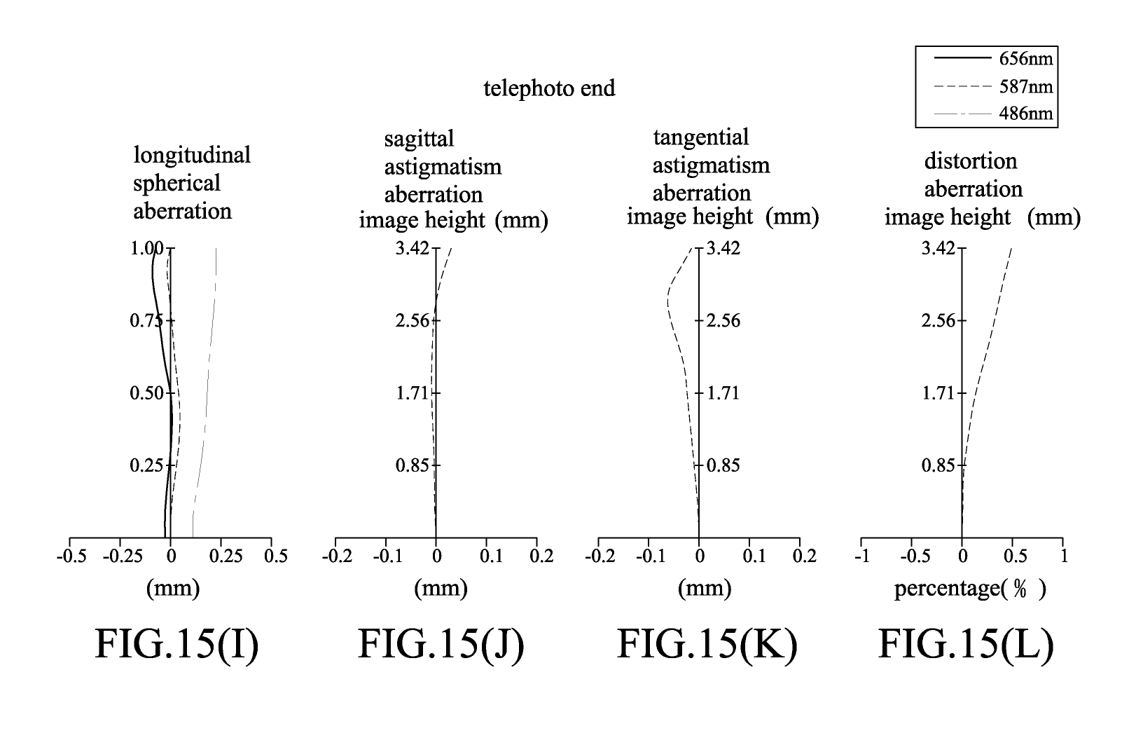

FIGS. 15(A) to 15(D) show simulation results at the wide angle end respectively corresponding to longitudinal spherical aberration, sagittal astigmatism aberration, tangential astigmatism aberration, and distortion aberration of the third embodiment. FIGS. 15(E) to 15(H) show simulation results at the intermediate position respectively corresponding to longitudinal spherical aberration, sagittal astigmatism aberration, tangential astigmatism aberration, and distortion aberration of the third embodiment. FIGS. 15(I) to 15(L) show simulation results at the telephoto end respectively corresponding to longitudinal spherical aberration, sagittal astigmatism aberration, tangential astigmatism aberration, and distortion aberration of the third embodiment. It can be understood from FIGS. 15(A) to 15(L) that the third embodiment is able to achieve a relatively good optical performance.

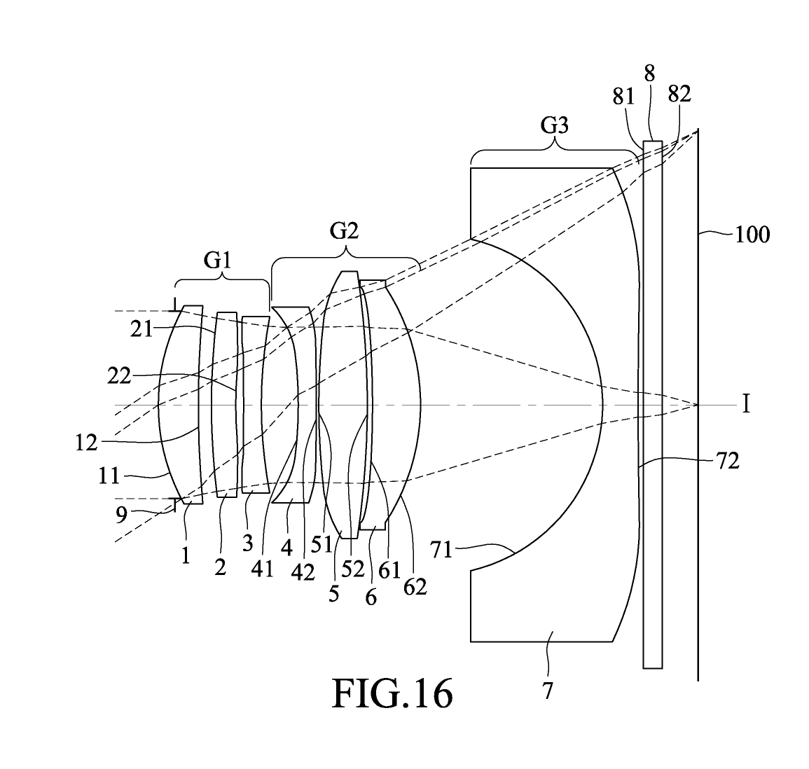

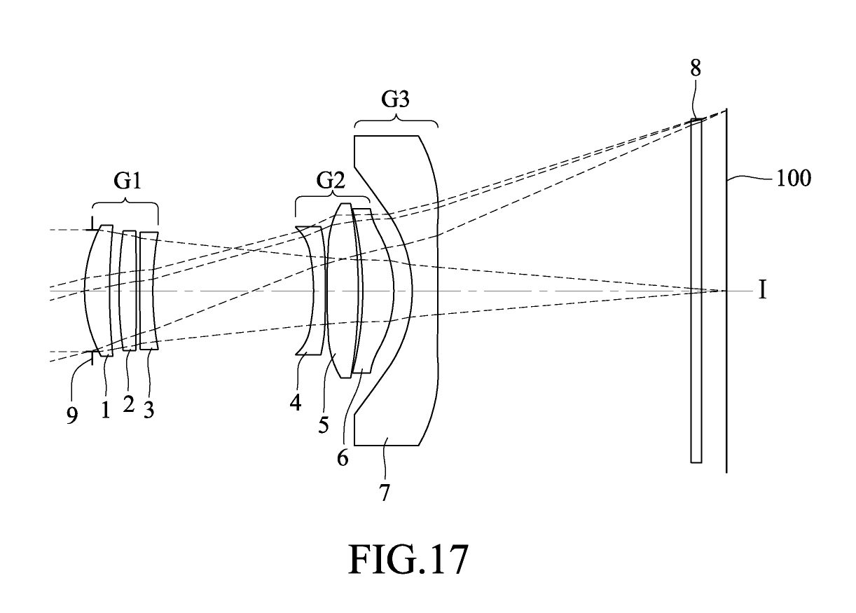

FIGS. 16 and 17 illustrates an imaging zoom lens of a fourth embodiment according to the present disclosure at a wide angle end and a telephoto end, respectively. The fourth embodiment has a configuration similar to that of the first embodiment and differs from the first embodiment in some of the quantity, the optical data, the aspherical coefficients and the lens parameters of the lens elements of the lens groups (G1-G3). Furthermore, in the fourth embodiment, the first lens group (G1) has an aperture stop 9 and includes first, second and third lens elements 1-3. The second lens group (G2) includes a fourth lens element 4, a fifth lens element 5 and a sixth lens element 6. The third lens group (G3) includes a seventh lens element 7. The aperture stop 9 and the first to seventh lens elements 1-7 are arranged in sequence from the object side to the image side along the optical axis (I).

The first lens element 1 has a positive refractive power. The object-side surface 11 of the first lens element 1 is a convex surface convex relative to the object side, and the image-side surface 12 of the first lens element is a concave surface concave relative to the image side. The second lens element 2 has a positive refractive power. The object-side surface 21 of the second lens element 2 is a convex surface convex relative to the object side, and the image-side surface 22 of the second lens element 2 is a concave surface concave relative to the image side. The third lens element 3 has a negative refractive power. The object-side and image-side surfaces 31, 32 of the third lens element 3 are concave surfaces respectively concave relative to the object and image sides. The fourth lens element 4 has a negative refractive power. The object-side surface 41 of the fourth lens element 4 is a concave surface concave relative to the object side, and the image-side surface 42 of the fourth lens element 4 is a convex surface convex relative to the image side. The fifth lens element 5 has a positive refractive power. The object-side and image-side surfaces 51, 52 of the fifth lens element 5 are convex surfaces respectively convex relative to the object and image sides. The sixth lens element 6 has a positive refractive power, an object-side surface 61 that is a concave surface concave relative to the object side, and an image-side surface 62 that is a convex surface convex relative to the image side. The seventh lens element 7 has a negative refractive power, an object-side surface 71 that is a concave surface concave relative to the object side, and an image-side surface 72 that is a concave surface concave relative to the image side. In this embodiment, each of the object-side surfaces 11, 21, 31, 41, 51, 61, 71 and the image-side surfaces 12, 22, 32, 42, 52, 62, 72 is aspherical and has a center point coinciding with the optical axis (I), and the imaging zoom lens does not include any lens element with a refractive power other than the first lens element 1, the second lens element 2, the third lens element 3, the fourth lens element 4, the fifth lens element 5, the sixth lens element 6 and the seventh lens element 7.

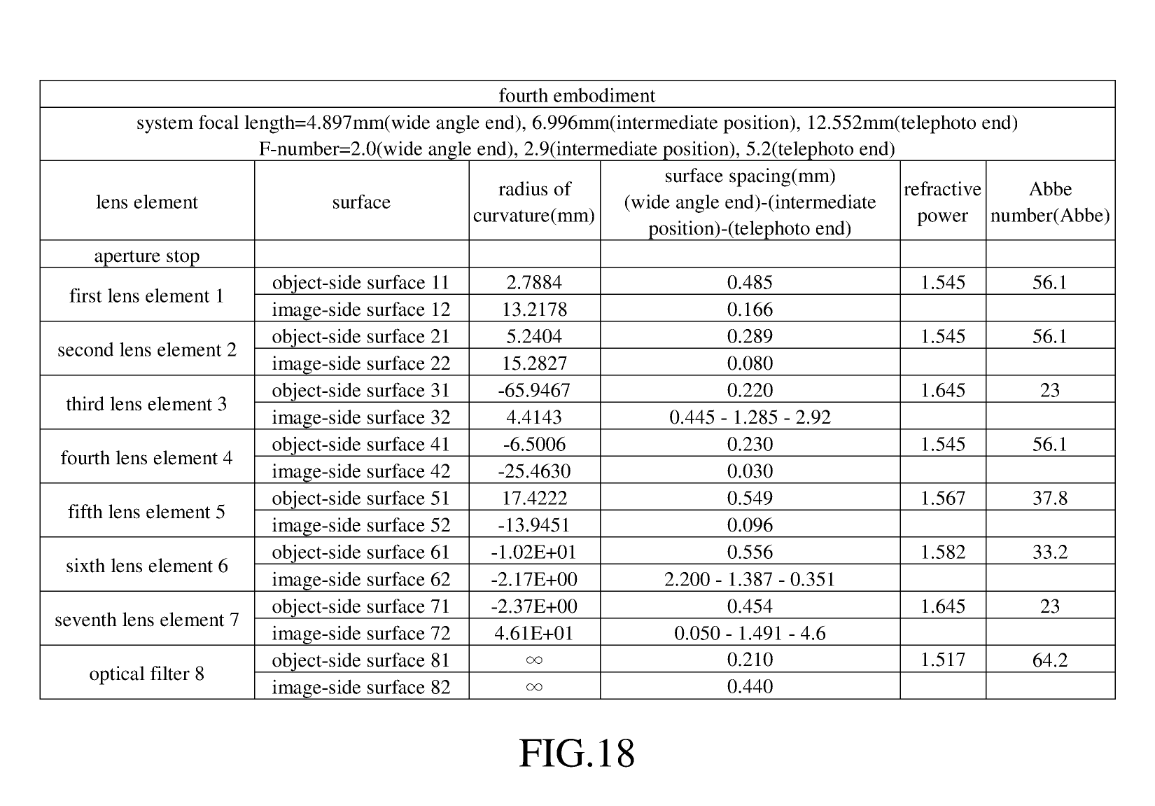

Shown in FIG. 18 is a table of the fourth embodiment that lists values of some optical data corresponding to the surfaces 11-71 and 81, 12-72 and 82 of the first to seventh lens elements 1-7 and the optical filter 8 when the imaging zoom lens is at the wide angle end, an intermediate position between the wide angle and telephoto ends, or the telephoto end.

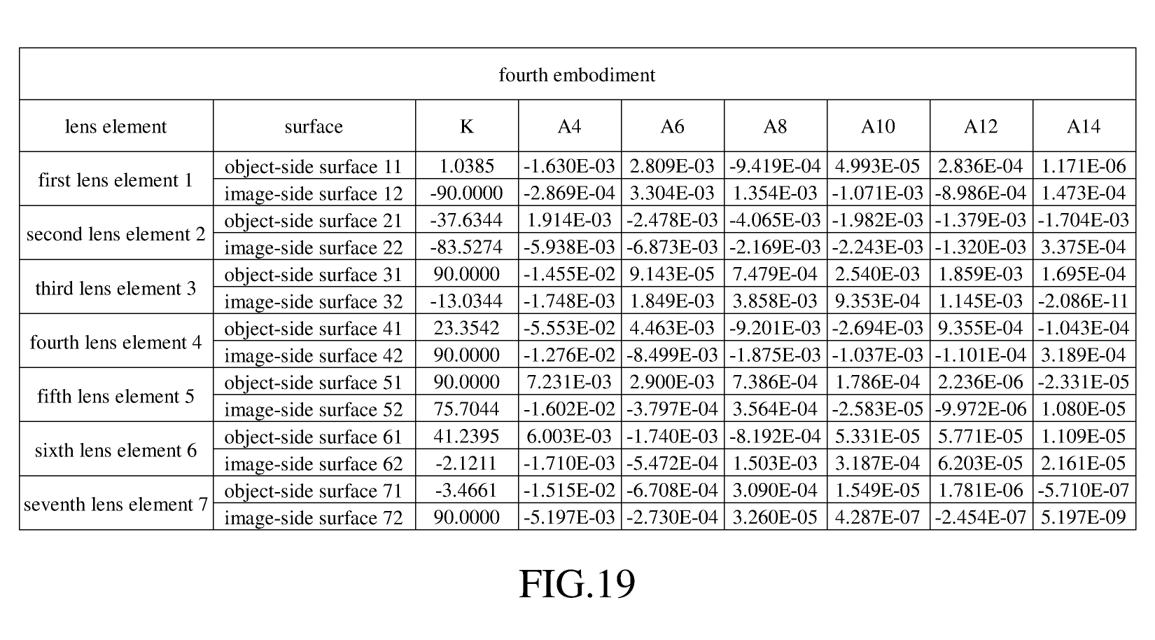

Shown in FIG. 19 is a table that lists values of some conic constants and aspherical coefficients of the aforementioned relationship (1) corresponding to the fourth embodiment.

Relationships among some of the aforementioned lens parameters corresponding to the fourth embodiment are listed in the columns of FIG. 36 corresponding to the fourth embodiment.

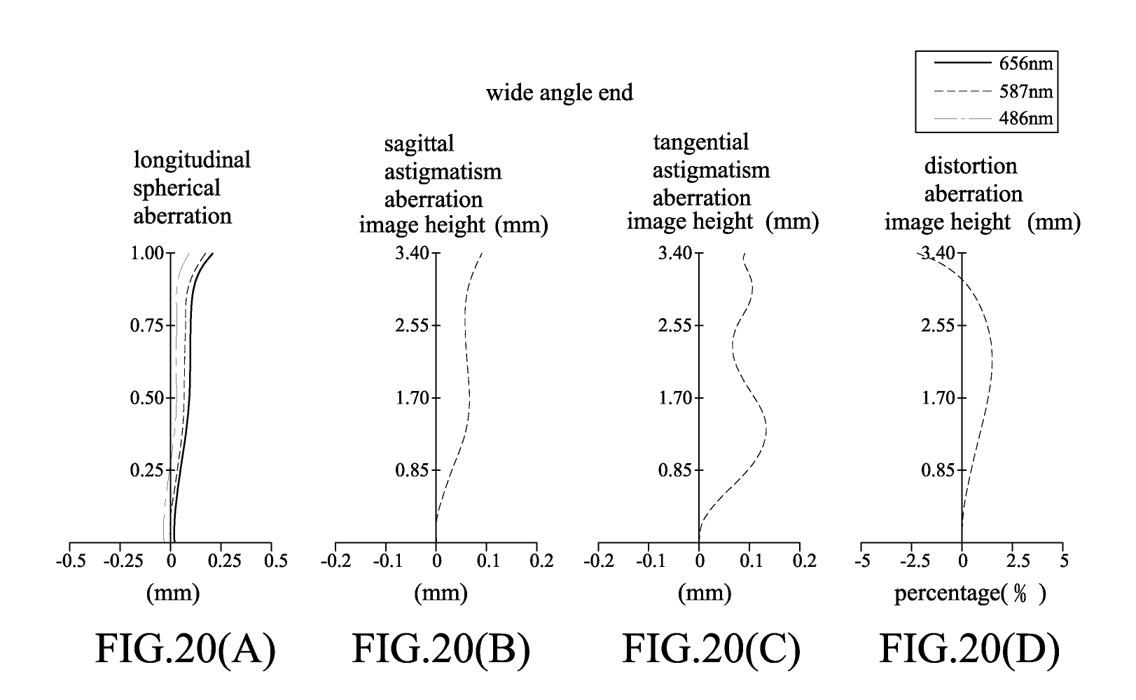

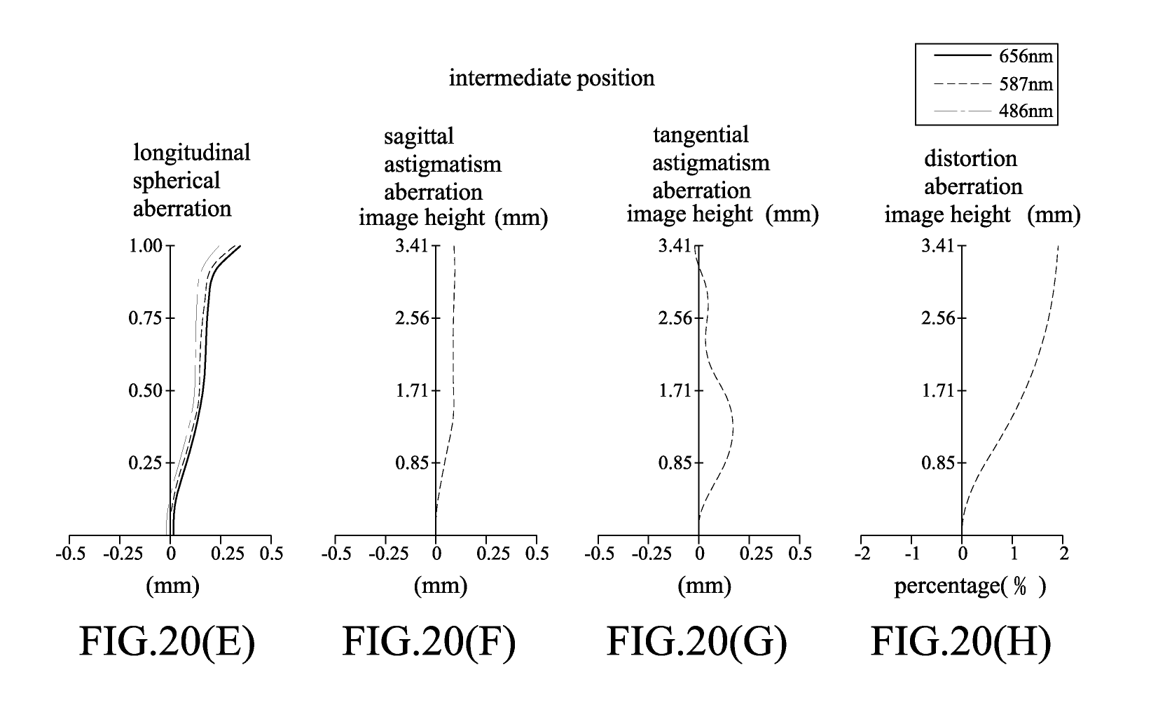

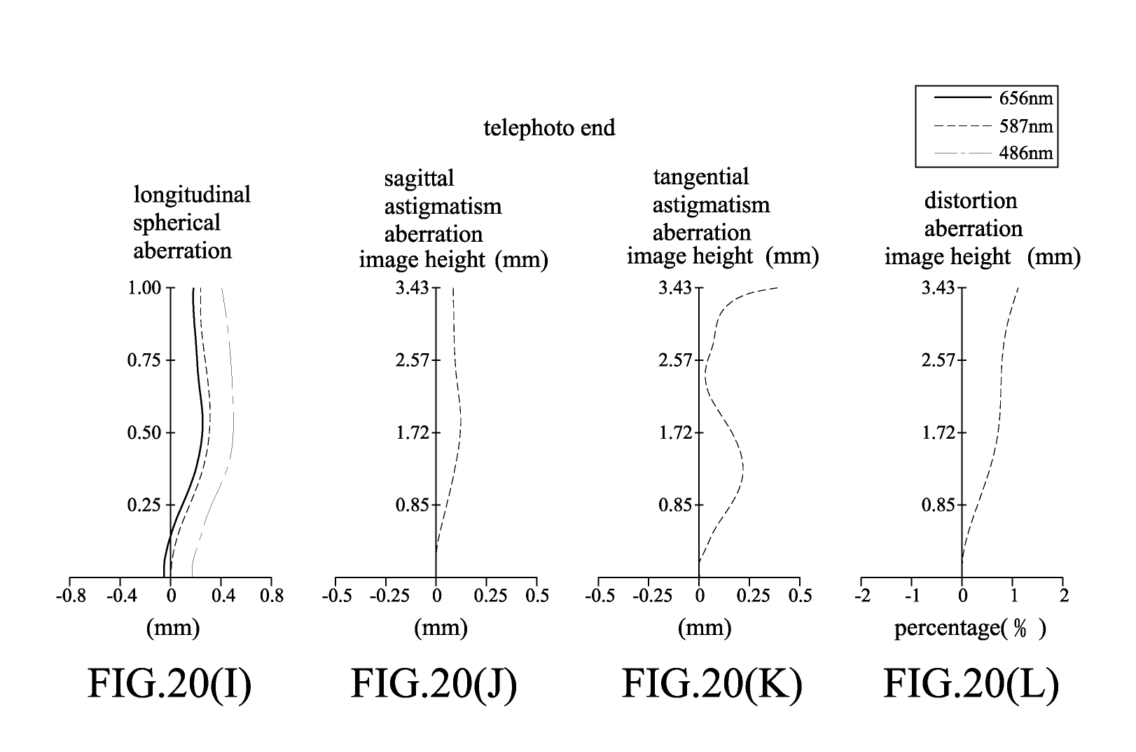

FIGS. 20(A) to 20(D) show simulation results at the wide angle end respectively corresponding to longitudinal spherical aberration, sagittal astigmatism aberration, tangential astigmatism aberration, and distortion aberration of the fourth embodiment. FIGS. 20(E) to 20(H) show simulation results at the intermediate position respectively corresponding to longitudinal spherical aberration, sagittal astigmatism aberration, tangential astigmatism aberration, and distortion aberration of the fourth embodiment. FIGS. 20(I) to 20(L) show simulation results at the telephoto end respectively corresponding to longitudinal spherical aberration, sagittal astigmatism aberration, tangential astigmatism aberration, and distortion aberration of the fourth embodiment. It can be understood from FIGS. 20(A) to 20(L) that the fourth embodiment is able to achieve a relatively good optical performance.

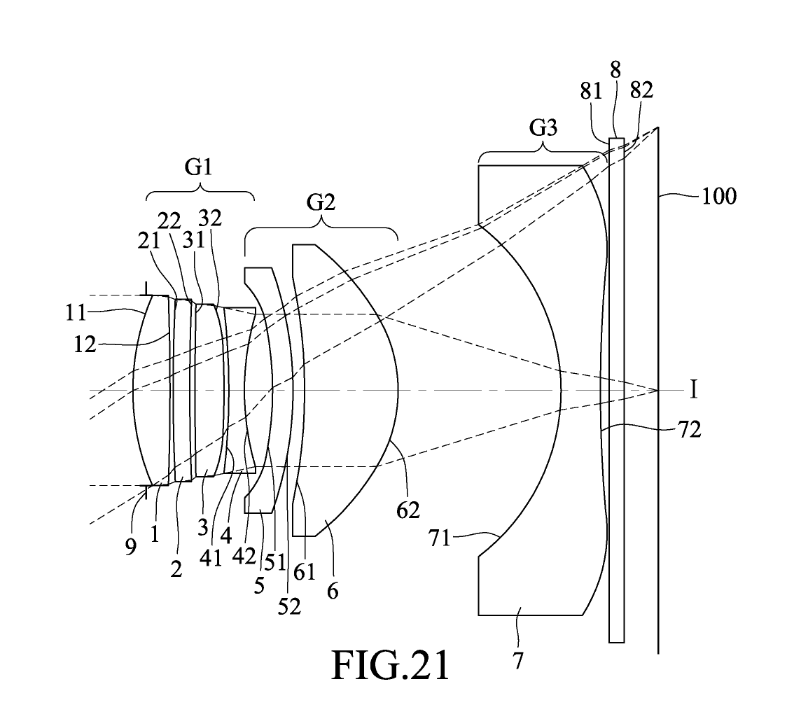

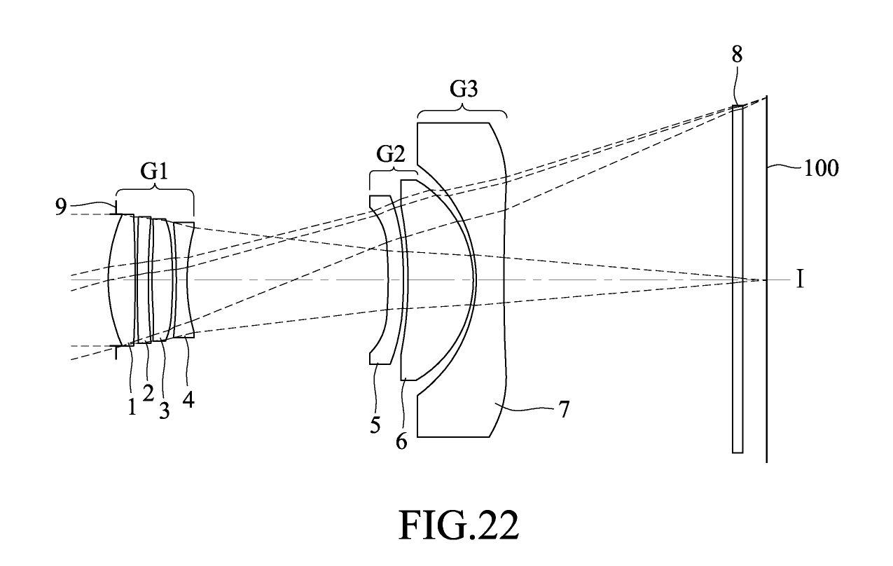

FIGS. 21 and 22 illustrates an imaging zoom lens of a fifth embodiment according to the present disclosure at a wide angle end and a telephoto end, respectively. The fifth embodiment has a configuration similar to that of the first embodiment, and differs from the first embodiment in some of the quantity, the optical data, the aspherical coefficients and the lens parameters of the lens elements of the lens groups (G1-G3). Furthermore, in the fifth embodiment, the first lens group (G1) has an aperture stop 9 and includes first, second, third and fourth lens elements 1-4. The second lens group (G2) includes a fifth lens element 5 and a sixth lens element 6. The third lens group (G3) includes a seventh lens element 7. The aperture stop 9 and the first to seventh lens elements 1-7 are arranged in sequence from the object side to the image side along the optical axis (I).

The first lens element 1 has a positive refractive power, and the object-side and image-side surfaces 11, 12 of the first lens element 1 are convex surfaces respectively convex relative to the object and image sides. The second lens element 2 has a negative refractive power, and the object-side and image-side surfaces 21, 22 of the second lens element 2 are concave surfaces concave relative to the object and image sides. The third lens element 3 has a positive refractive power, and the object-side and image-side surfaces 31, 32 of the third lens element 3 are convex surfaces respectively convex relative to the object and image sides. The fourth lens element 4 has a negative refractive power, and the object-side and images-side surfaces 41, 42 of the fourth lens element 4 are concave surfaces respectively concave relative to the object and image sides. The fifth lens element 5 has a positive refractive power. The object-side surface 51 of the fifth lens element 5 is a concave surface concave relative to the object side, and the image-side surface 52 of the fifth lens element 5 is a convex surface convex relative to the image side. The sixth lens element 6 has a positive refractive power, an object-side surface 61 that is a concave surface concave relative to the object side, and an image-side surface 62 that is a convex surface convex relative to the image side. The seventh lens element 7 has a negative refractive power, an object-side surface 71 that is a concave surface concave relative to the object side, and an image-side surface 72 that is a concave surface concave relative to the image side. In this embodiment, each of the object-side surfaces 11, 21, 31, 41, 51, 61, 71 and the image-side surfaces 12, 22, 32, 42, 52, 62, 72 is aspherical and has a center point coinciding with the optical axis (I), and the imaging zoom lens does not include any lens element with a refractive power other than the first lens element 1, the second lens element 2, the third lens element 3, the fourth lens element 4, the fifth lens element 5, the sixth lens element 6 and the seventh lens element 7.

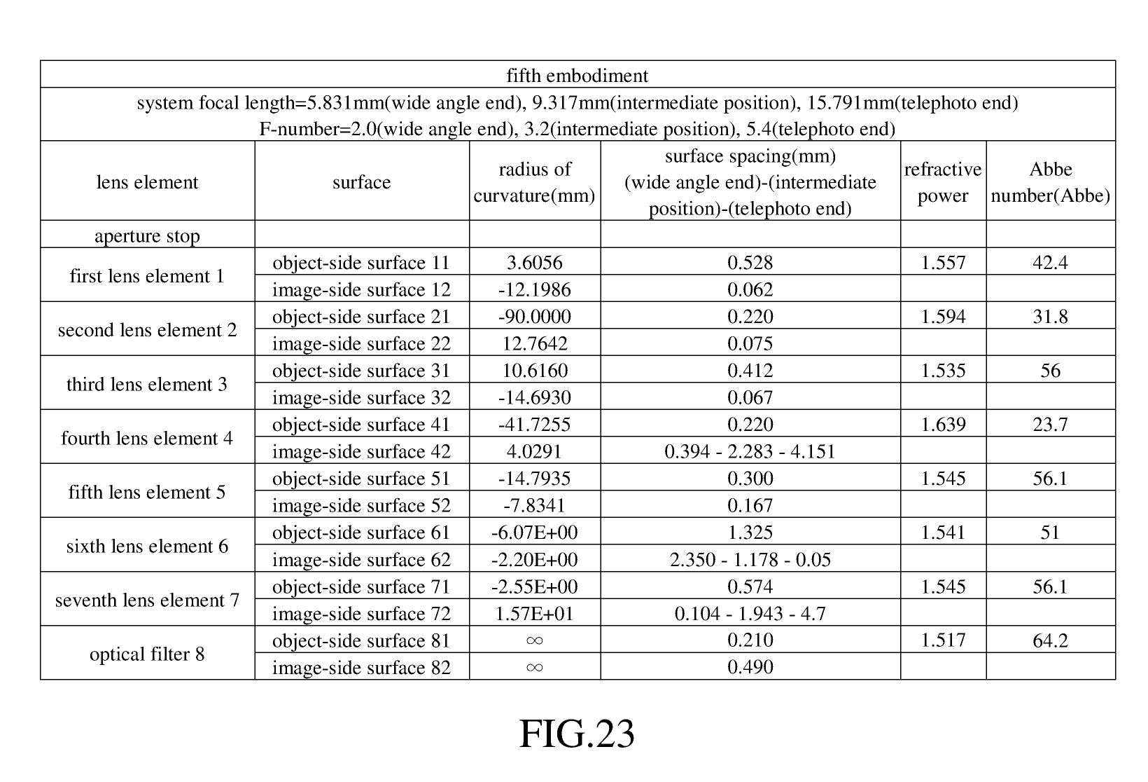

Shown in FIG. 23 is a table of the fifth embodiment that lists values of some optical data corresponding to the surfaces 11-71 and 81, 12-72 and 82 of the first to seventh lens elements 1-7 and the optical filter 8 when the imaging zoom lens is at the wide angle end, an intermediate position between the wide angle and telephoto ends, or the telephoto end.

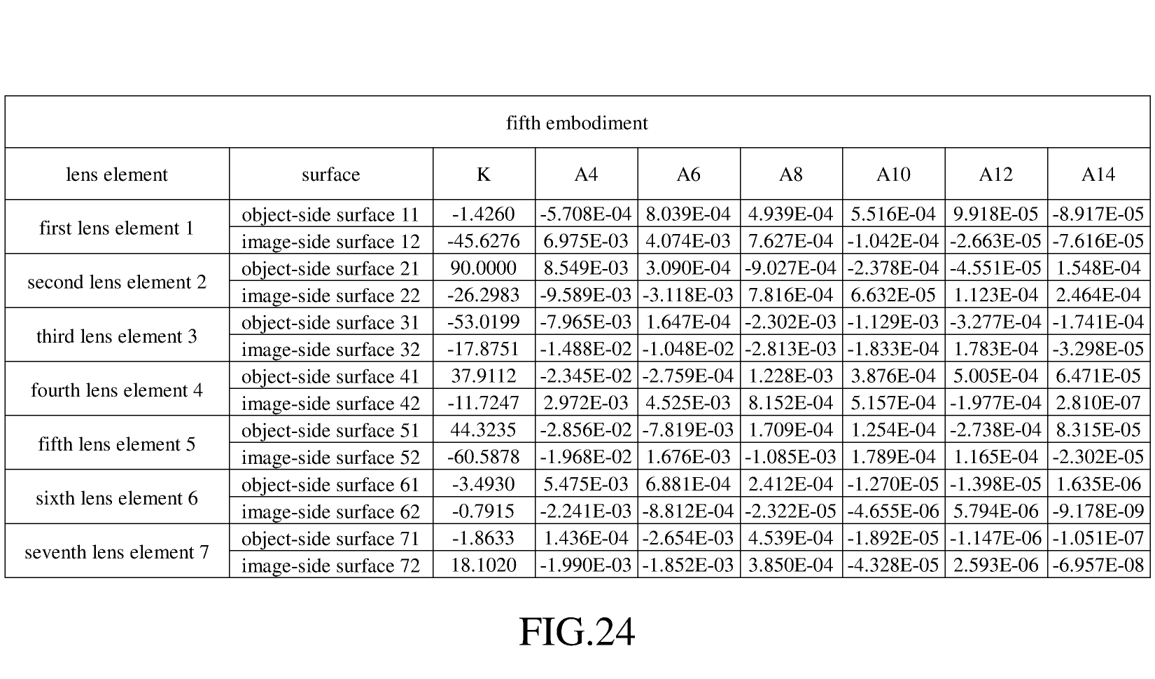

Shown in FIG. 24 is a table that lists values of some conic constants and aspherical coefficients of the aforementioned relationship (1) corresponding to the fifth embodiment.

Relationships among some of the aforementioned lens parameters corresponding to the fifth embodiment are listed in the columns of FIG. 36 corresponding to the fifth embodiment.

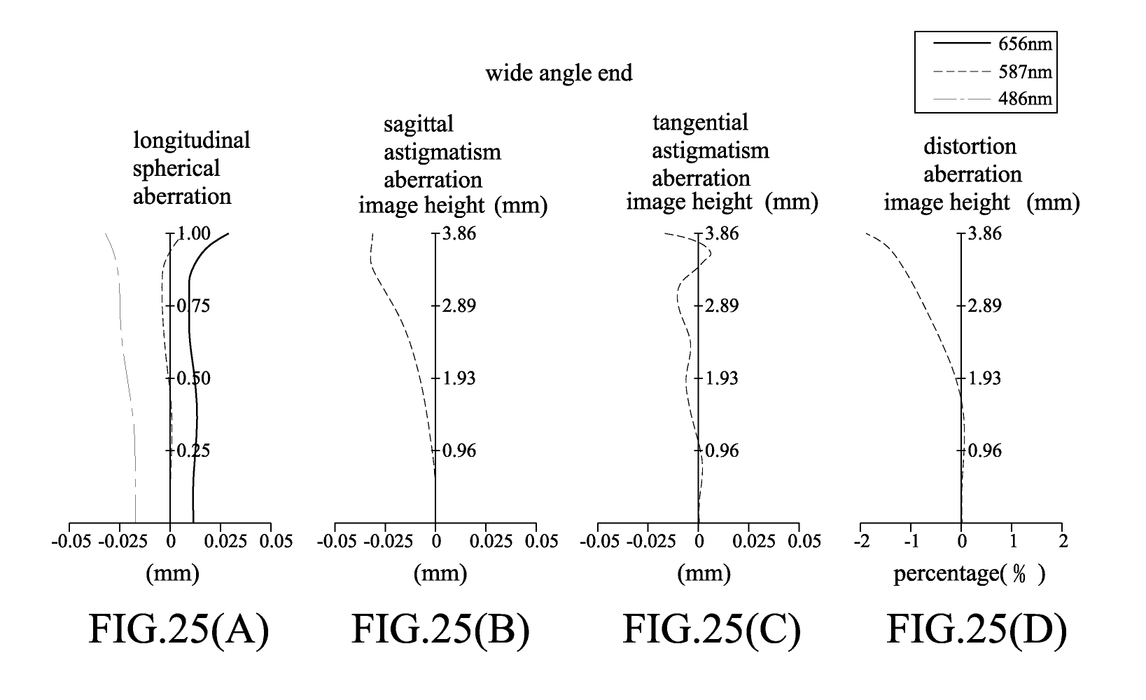

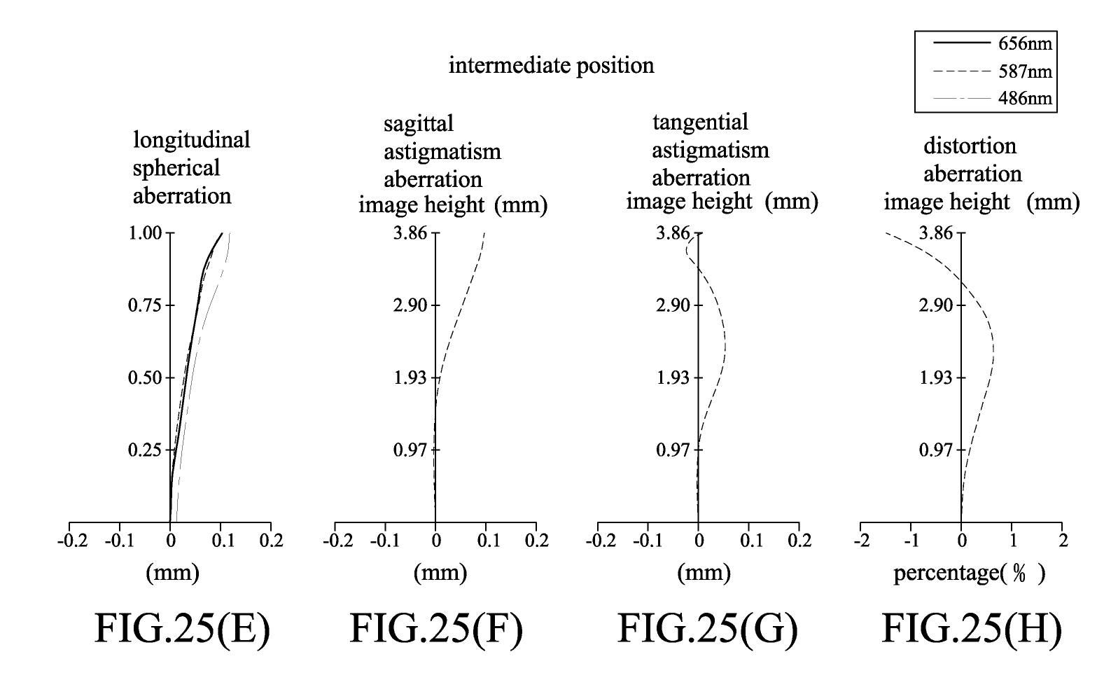

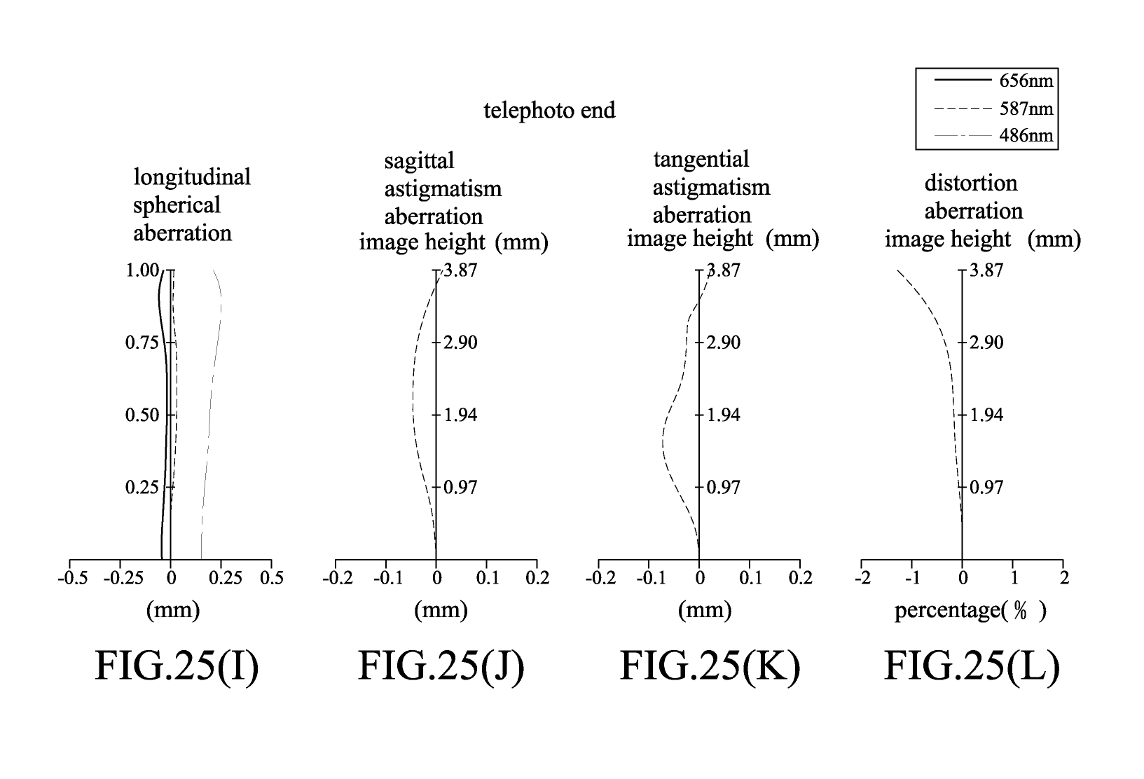

FIGS. 25(A) to 25(D) show simulation results at the wide angle end respectively corresponding to longitudinal spherical aberration, sagittal astigmatism aberration, tangential astigmatism aberration, and distortion aberration of the fifth embodiment. FIGS. 25(E) to 25(H) show simulation results at the intermediate position respectively corresponding to longitudinal spherical aberration, sagittal astigmatism aberration, tangential astigmatism aberration, and distortion aberration of the fifth embodiment. FIGS. 25(I) to 25(L) show simulation results at the telephoto end respectively corresponding to longitudinal spherical aberration, sagittal astigmatism aberration, tangential astigmatism aberration, and distortion aberration of the fifth embodiment. It can be understood from FIGS. 25(A) to 25(L) that the fifth embodiment is able to achieve a relatively good optical performance.

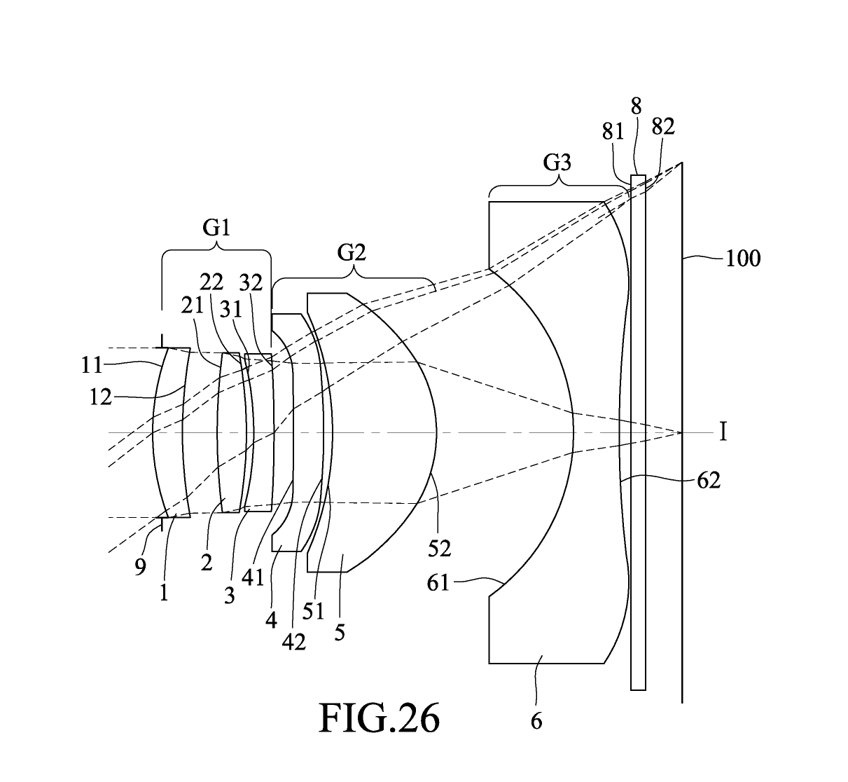

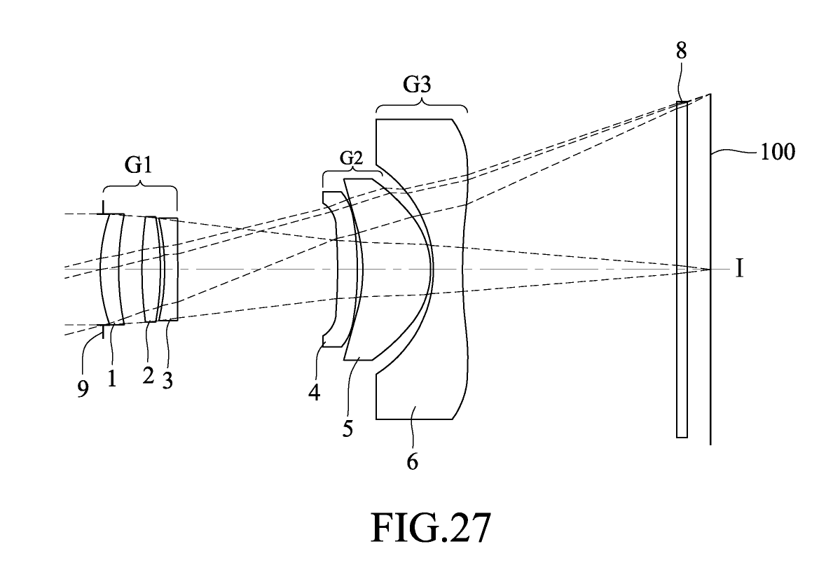

FIGS. 26 and 27 illustrates an imaging zoom lens of a sixth embodiment according to the present disclosure at a wide angle end and a telephoto end, respectively. The sixth embodiment has a configuration similar to that of the first embodiment, and differs from the first embodiment in some of the quantity, the optical data, the aspherical coefficients and the lens parameters of the lens elements of the lens groups (G1-G3). Furthermore, in the sixth embodiment, the first lens group (G1) has an aperture stop 9 and includes first, second, and third lens elements 1-3. The second lens group (G2) includes a fourth lens element 4 and a fifth lens element 5. The third lens group (G3) includes a sixth lens element 6. The aperture stop 9 and the first to sixth lens elements 1-6 are arranged in sequence from the object side to the image side along the optical axis (I).

The first lens element 1 has a positive refractive power. The object-side surface 11 of the first lens element 1 is a convex surface convex relative to the object side, and the image-side surface 12 of the first lens element 1 is a concave surface concave relative to the image side. The second lens element 2 has a positive refractive power, and the object-side and image-side surfaces 21, 22 of the second lens element 2 are convex surfaces respectively convex relative to the object and image sides. The third lens element 3 has a negative refractive power, and the object-side and image-side surfaces 31, 32 of the third lens element 3 are concave surfaces respectively concave relative to the object and image sides. The fourth lens element 4 has a positive refractive power, and the object-side and images-side surfaces 41, 42 of the fourth lens element 4 are convex surfaces respectively convex relative to the object and image sides. The fifth lens element 5 has a positive refractive power. The object-side surface 51 of the fifth lens element 5 is a concave surface concave relative to the object side, and the image-side surface 52 of the fifth lens element 5 is a convex surface convex relative to the image side. The sixth lens element 6 has a negative refractive power, an object-side surface 61 that is a concave surface concave relative to the object side, and an image-side surface 62 that is a concave surface concave relative to the image side. In this embodiment, each of the object-side surfaces 11, 21, 31, 41, 51, 61 and the image-side surfaces 12, 22, 32, 42, 52, 62 is aspherical and has a center point coinciding with the optical axis (I), and the imaging zoom lens does not include any lens element with a refractive power other than the first lens element 1, the second lens element 2, the third lens element 3, the fourth lens element 4, the fifth lens element 5 and the sixth lens element 6.

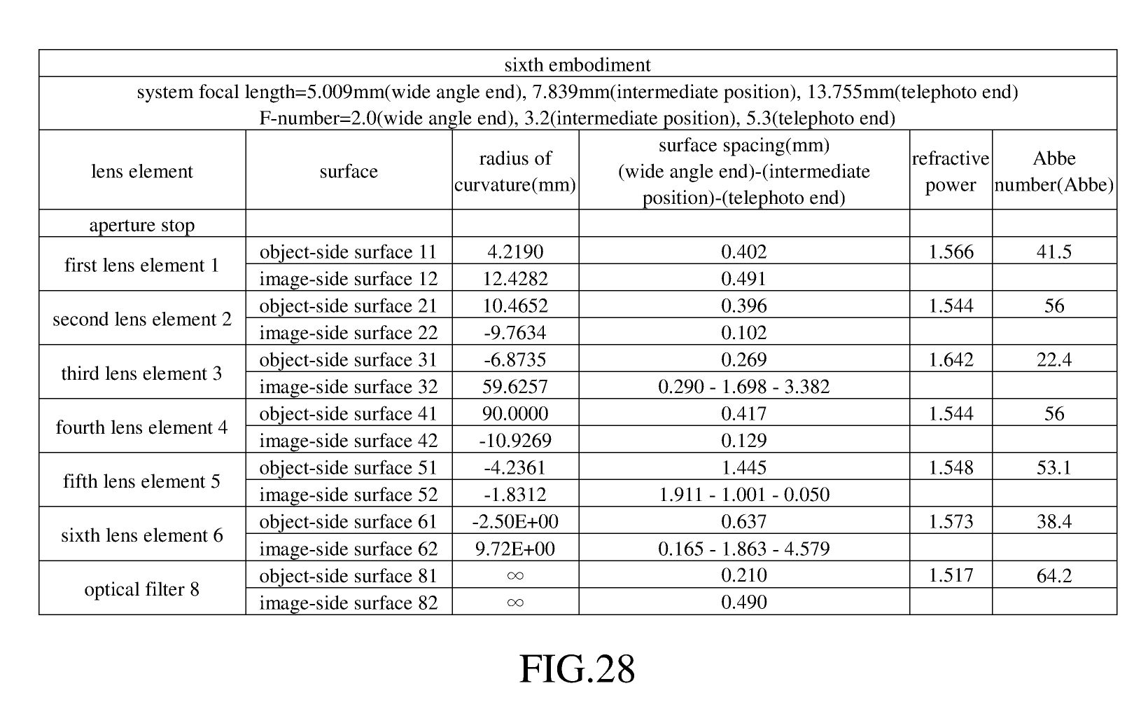

Shown in FIG. 28 is a table of the sixth embodiment that lists values of some optical data corresponding to the surfaces 11-61 and 81, 12-62 and 82 of the first to sixth lens elements 1-6 and the optical filter 8.

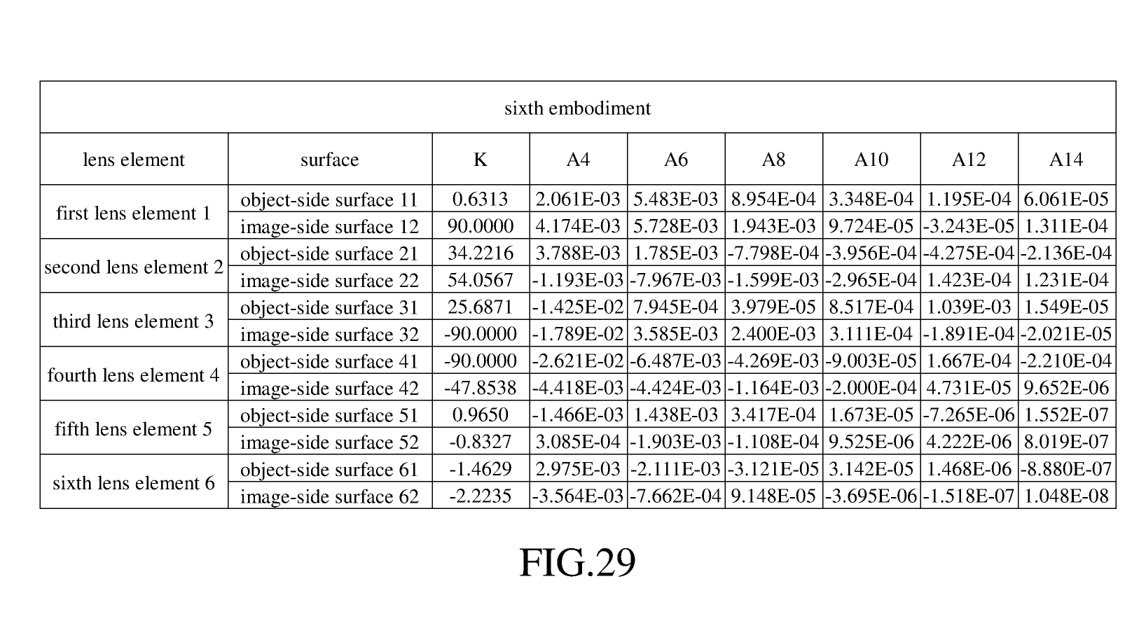

Shown in FIG. 29 is a table that lists values of some conic constants and aspherical coefficients of the aforementioned relationship (1) corresponding to the sixth embodiment.

Relationships among some of the aforementioned lens parameters corresponding to the sixth embodiment are listed in the columns of FIG. 36 corresponding to the sixth embodiment.

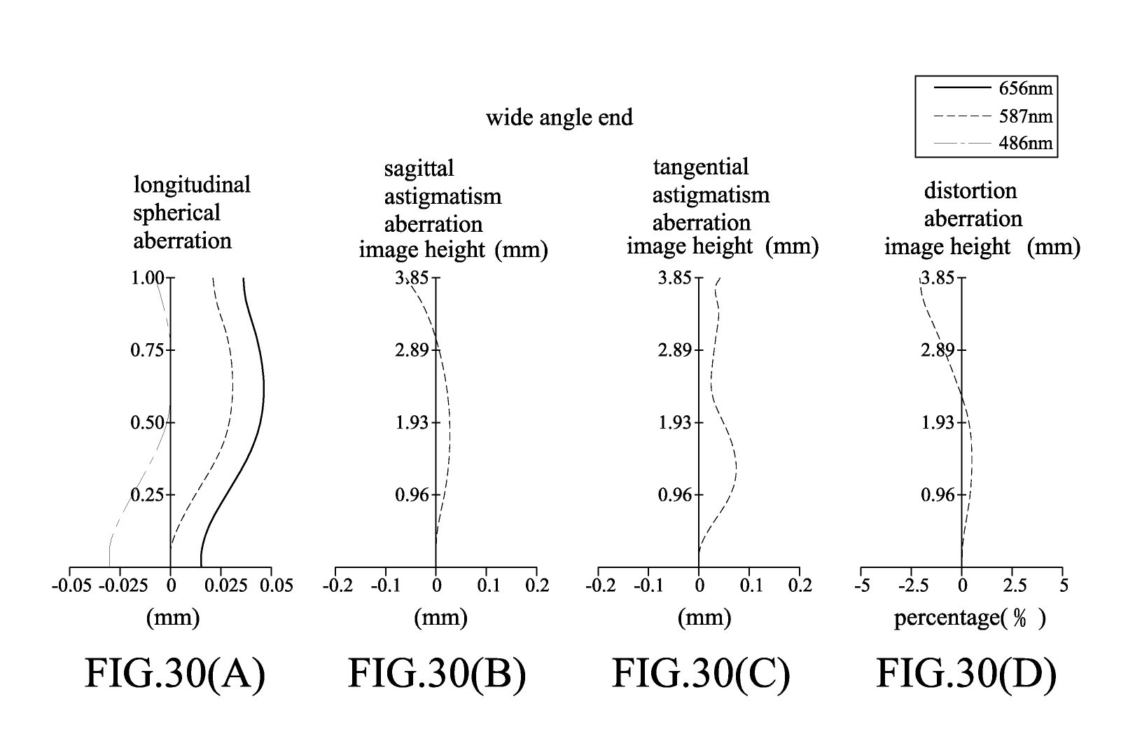

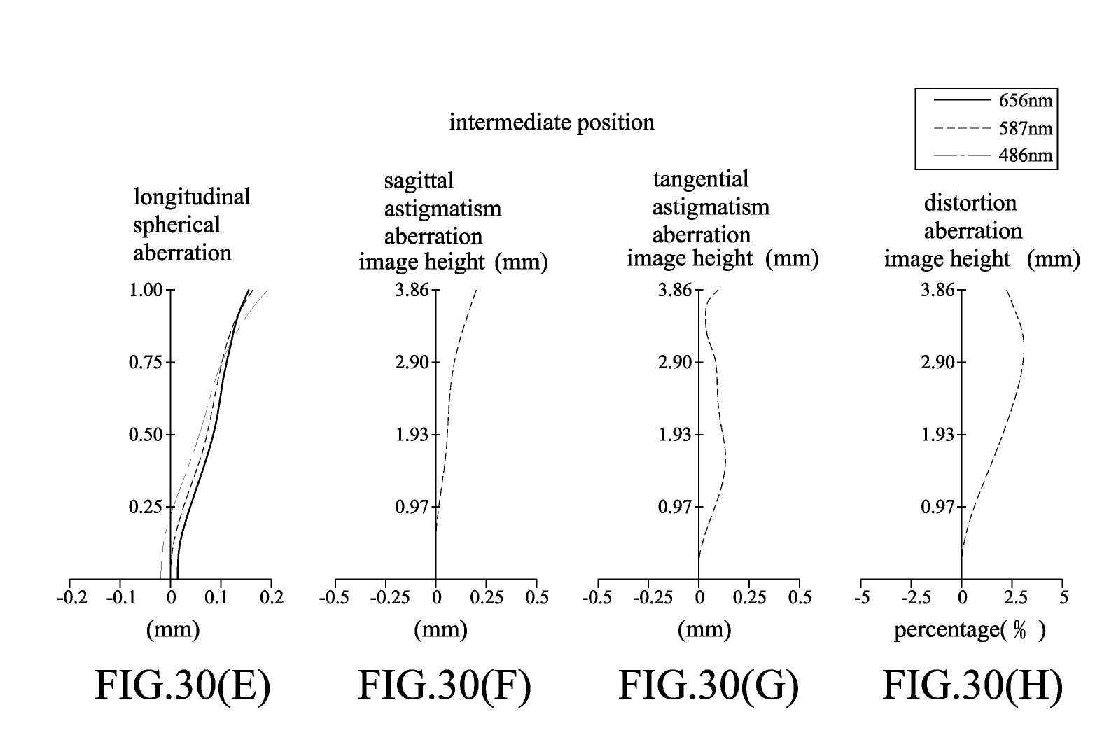

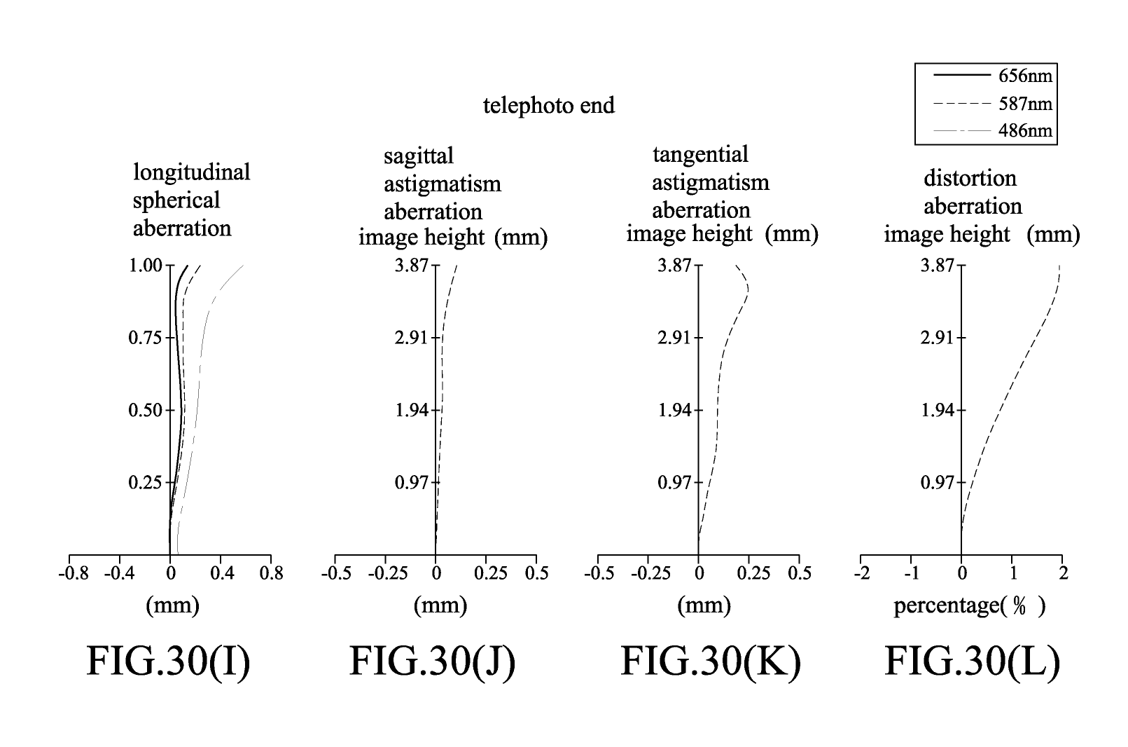

FIGS. 30(A) to 30(D) show simulation results at the wide angle end respectively corresponding to longitudinal spherical aberration, sagittal astigmatism aberration, tangential astigmatism aberration, and distortion aberration of the sixth embodiment. FIGS. 30(E) to 30(H) show simulation results at the intermediate position respectively corresponding to longitudinal spherical aberration, sagittal astigmatism aberration, tangential astigmatism aberration, and distortion aberration of the sixth embodiment. FIGS. 30(I) to 30(L) show simulation results at the telephoto end respectively corresponding to longitudinal spherical aberration, sagittal astigmatism aberration, tangential astigmatism aberration, and distortion aberration of the sixth embodiment. It can be understood from FIGS. 30(A) to 30(L) that the sixth embodiment is able to achieve a relatively good optical performance.

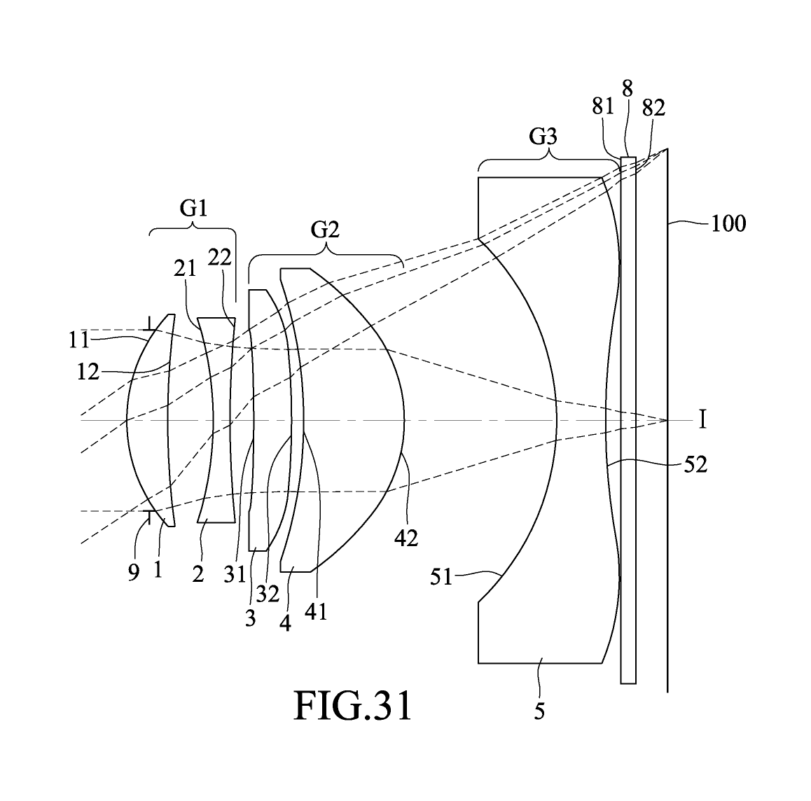

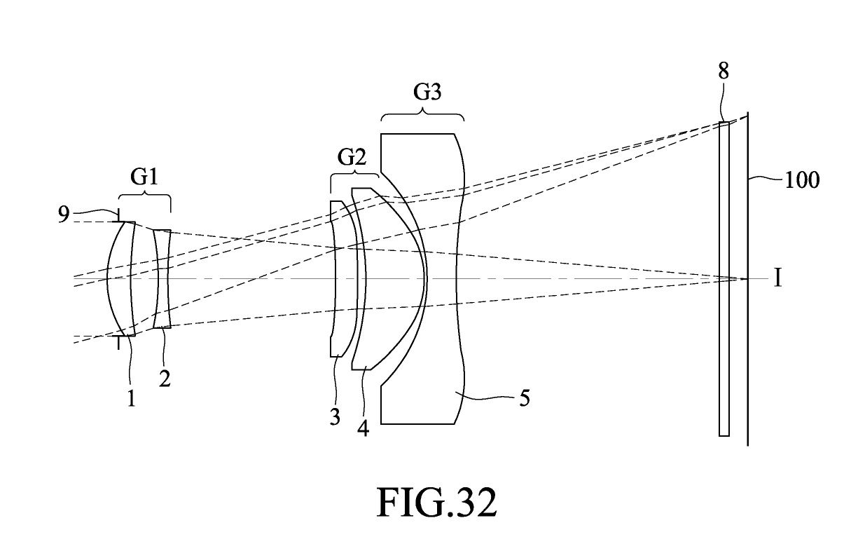

FIGS. 31 and 32 illustrates an imaging zoom lens of a seventh embodiment according to the present disclosure at a wide angle end and a telephoto end, respectively. The seventh embodiment has a configuration similar to that of the first embodiment, and differs from the first embodiment in some of the quantity, the optical data, the aspherical coefficients and the lens parameters of the lens elements of the lens groups (G1-G3). Furthermore, in the seventh embodiment, the first lens group (G1) has an aperture stop 9 and includes first and second lens elements 1, 2. The second lens group (G2) includes third and fourth lens elements 3, 4. The third lens group (G3) includes a fifth lens element 5. The aperture stop 9 and the first to fifth lens elements 1-5 are arranged in sequence from the object side to the image side along the optical axis (I).

The first lens element 1 has a positive refractive power. The object-side surface 11 of the first lens element 1 is a convex surface convex relative to the object side, and the image-side surface 12 of the first lens element 1 is a concave surface concave relative to the image side. The second lens element 2 has a negative refractive power, and the object-side and image-side surfaces 21, 22 of the second lens element 2 are concave surfaces respectively concave relative to the object and image sides. The third lens element 3 has a positive refractive power, and the object-side and image-side surfaces 31, 32 of the third lens element 3 are convex surfaces respectively convex relative to the object and image sides. The fourth lens element 4 has a positive refractive power. The object-side surface 41 of the fourth lens element 4 is a concave surface concave relative to the object side, and the image-side surface 42 of the fourth lens element 4 is a convex surface convex relative to the image side. The fifth lens element 5 has a negative refractive power, and the object-side and image-side surfaces 51, 52 of the fifth lens element 5 are concave surfaces respectively concave relative to the object and image sides. In this embodiment, each of the object-side surfaces 11, 21, 31, 41, 51 and the image-side surfaces 12, 22, 32, 42, 52 is aspherical and has a center point coinciding with the optical axis (I), and the imaging zoom lens does not include any lens element with a refractive power other than the first lens element 1, the second lens element 2, the third lens element 3, the fourth lens element 4 and the fifth lens element 5.

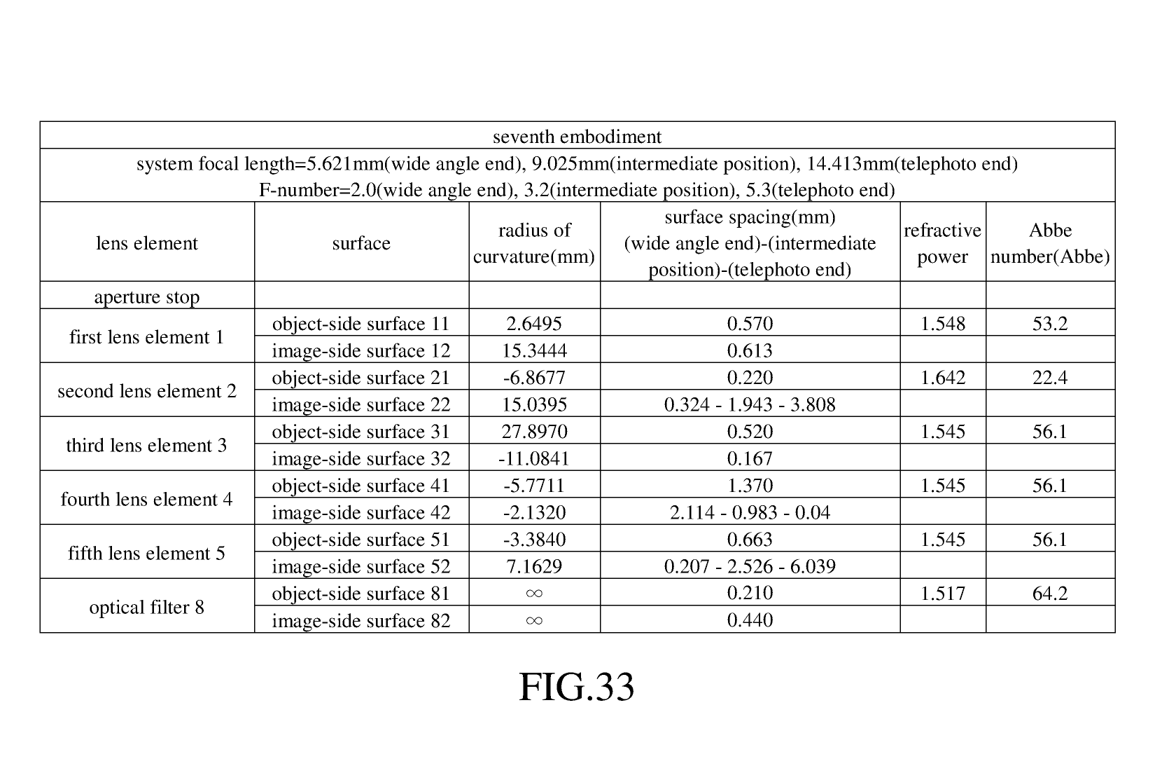

Shown in FIG. 33 is a table of the seventh embodiment that lists values of some optical data corresponding to the surfaces 11-51 and 81, 12-52 and 82 of the first to fifth lens elements 1-5 and the optical filter 8.

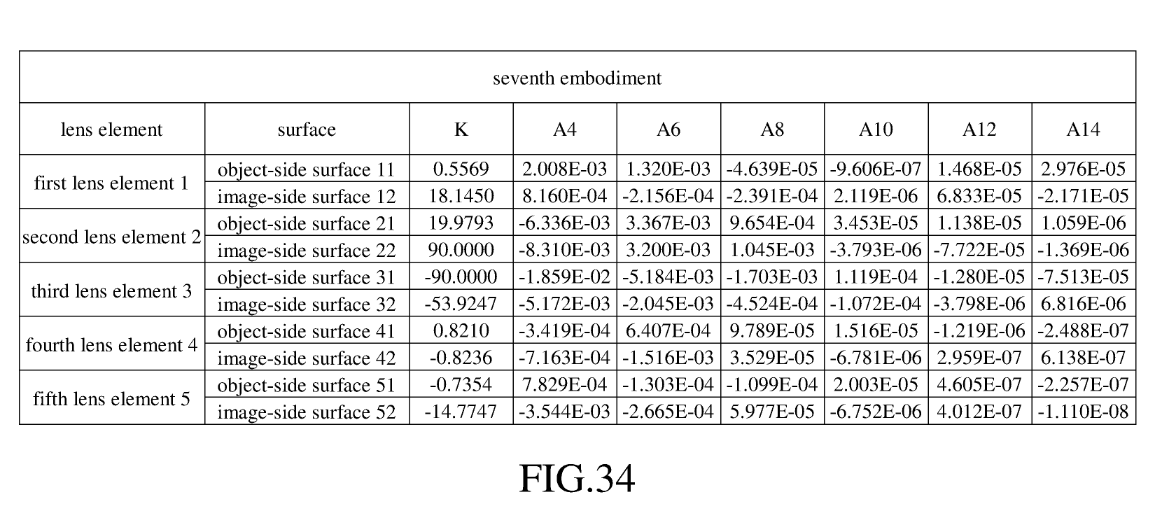

Shown in FIG. 34 is a table that lists values of some conic constants and aspherical coefficients of the aforementioned relationship (1) corresponding to the seventh embodiment.

Relationships among some of the aforementioned lens parameters corresponding to the seventh embodiment are listed in the columns of FIG. 36 corresponding to the seventh embodiment.

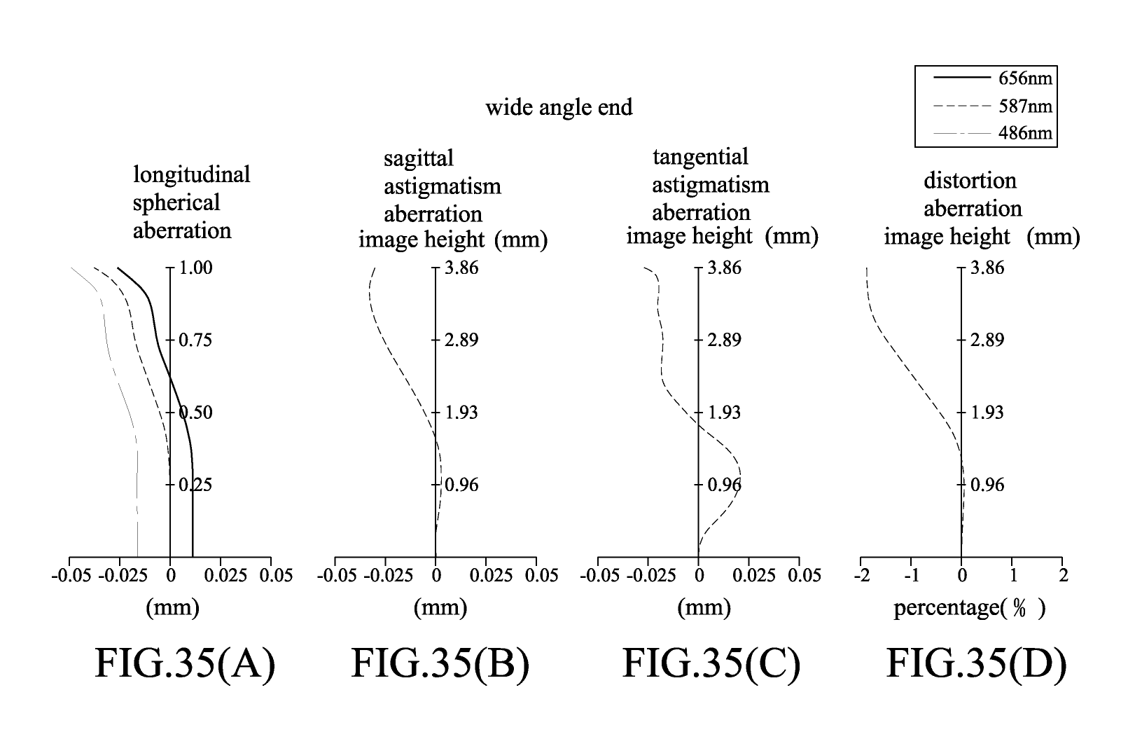

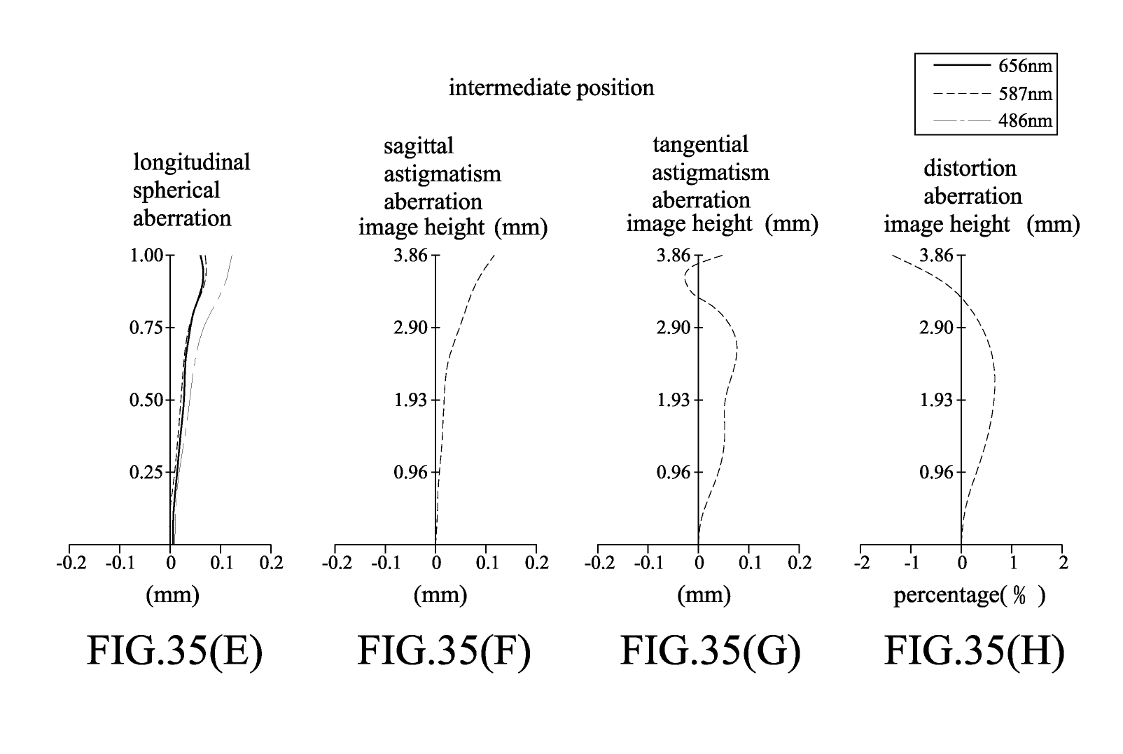

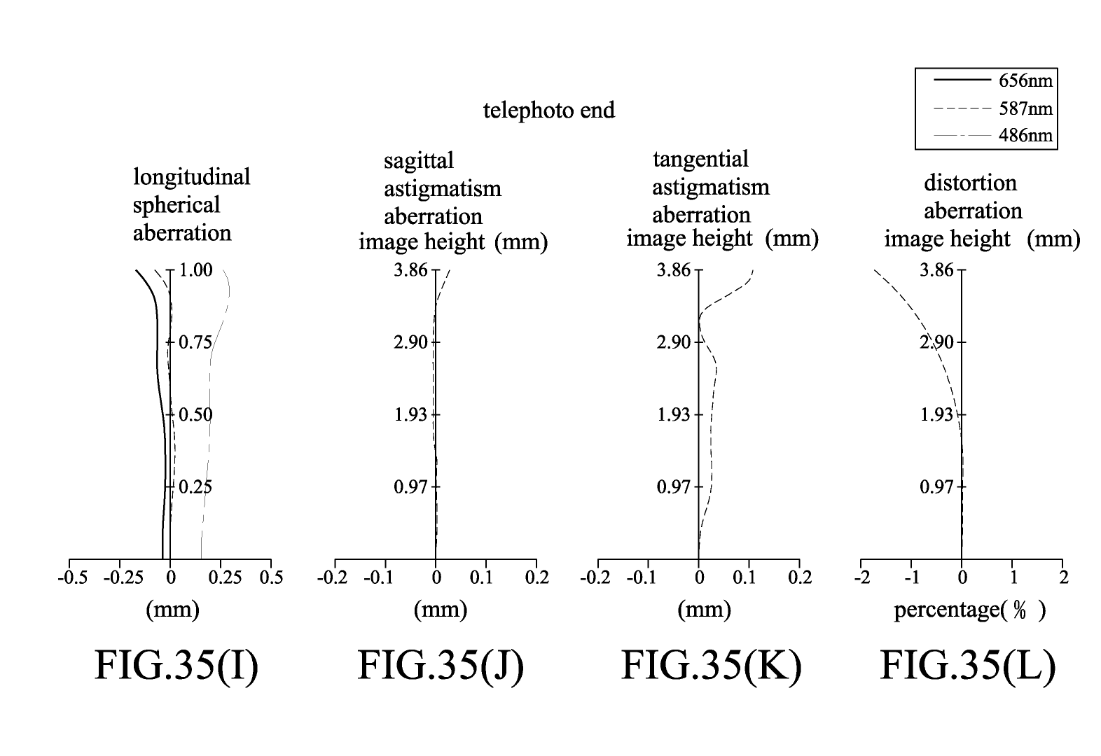

FIGS. 35(A) to 35(D) show simulation results at the wide angle end respectively corresponding to longitudinal spherical aberration, sagittal astigmatism aberration, tangential astigmatism aberration, and distortion aberration of the seventh embodiment. FIGS. 35(E) to 35(H) show simulation results at the intermediate position respectively corresponding to longitudinal spherical aberration, astigmatism aberration, and distortion aberration of the seventh embodiment. FIGS. 35(I) to 35(L) show simulation results at the telephoto end respectively corresponding to longitudinal spherical aberration, sagittal astigmatism aberration, tangential astigmatism aberration, and distortion aberration of the seventh embodiment. It can be understood from FIGS. 35(A) to 35(L) that the seventh embodiment is able to achieve a relatively good optical performance.

Shown in FIG. 36 is the table that lists the aforesaid relationships among some of the aforementioned lens parameters corresponding to the seven embodiments for comparison. When each of the lens parameters of the imaging zoom lens according to this disclosure satisfies the optical relationships disclosed below, the optical performance is still relatively good:

(1) Since the first lens group (G1) has the aperture stop 9 and a relatively small effective focal length (f1), and each lens element thereof has a relatively small radius of curvature, the first lens group (G1) may introduce relatively greater aberration. However, when the imaging zoom lens satisfies 1.31<f1/fw<2.87, the first lens group (G1) can effectively share a portion of refractive power required by the first and second lens groups (G1, G2) as a whole, and the aberration may be uniformly distributed. In some embodiments, the imaging zoom lens may further satisfy 1.69<f1/fw<2.43 to achieve better effects. An excessively small f1/fw may cause aberration introduced by the first lens group (G1) to become greater, while an excessive large f1/fw may prevent the first lens group (G1) from effectively sharing a sufficient portion of refractive power required by the first and second lens groups (G1, G2) as a whole.

(2) Since the effective focal length (f2) of the second lens group (G2) is relatively small, the movement of the second lens group (G2) can effectively change the system focal length of the imaging zoom lens. Hence, when the imaging zoom lens satisfies 0.62<f2/fw<1.06, the zoom magnification ratio of the imaging zoom lens can be effectively increased. In some embodiments, the imaging zoom lens may further satisfy 0.69<f2/fw<0.98 to achieve better effects. An excessively small f2/fw may cause aberration introduced by the second lens group (G2) to become greater, while an excessively large f2/fw may lead to small zoom magnification ratio of the imaging zoom lens.

(3) By virtue of the negative effective focal length of the third lens group (G3) cooperating with the distance between the second and third lens groups (G2, G3), positive refractive powers of the first and second lens groups (G1, G2) can be effectively balanced, such that aberration caused by the third lens group (G3) can be minimized. Hence, when the imaging zoom lens satisfies 0.45<|f3|/fw<1.00, good imaging quality of the imaging zoom lens can be retained. In some embodiments, the imaging zoom lens may further satisfy 0.58<|f3|/fw<0.83 to achieve better effects. However, an excessively small |f3|/fw may cause aberration introduced by the third lens group (G2) to become greater, and an excessively large |f3|/fw may prevent aberration of the imaging zoom lens from being well-balanced.

(4) A lower TTLw/ImagH refers to a smaller system size of the imaging zoom lens, and leads to more difficulty in designing, manufacturing and assembling the imaging zoom lens. On the other hand, a greater TTLw/ImagH refers to a bigger system size of the imaging zoom lens. If the imaging zoom lens satisfies 1.33<TTLw/ImagH<4.00, a better arrangement of the imaging zoom lens can be achieved to meet lightweight and miniaturization requirements without greatly increasing difficulty in designing, manufacturing and assembling the imaging zoom lens. In some embodiments, the imaging zoom lens may further satisfy 1.71<TTLw/ImagH<2.14 to achieve better effects.

(5) A higher ft/fw refers to a greater zoom magnification ratio of the imaging zoom lens, and leads to greater movements of the lens groups (G1-G3) along the optical axis (I) and larger F-number, resulting in a lower light collection efficiency. If the imaging zoom lens satisfies 1.50<ft/fw<5.00, the imaging zoom lens may have an appropriate zoom magnification ratio while maintaining a proper F-number, thereby achieving a relatively good light collection efficiency. In some embodiments, the imaging zoom lens may further satisfy 2.30<ft/fw<3.00 to achieve better effects.

Other surface designs for one or more lens elements of the imaging zoom lens, such as different arrangements/combinations of concave/convex surfaces, may be applied to other embodiments of this disclosure in order to enhance control of optical performance of the imaging zoom lens. However, these additional surface designs should be selectively combined with each other without violation of the abovementioned relationships in those embodiments of this disclosure.

To sum up, effects and advantages of the imaging zoom lens according to the disclosure are described hereinafter.

1. Since the effective focal length of the first lens group (G1) is positive and relatively small, the first lens group (G1) is favorable for focusing light. By disposing the aperture stop 9 in proximity to the object side, the first lens group (G1) can contributively share a portion of refractive power required by the first and second lens group (G1, G2) as a whole, and the aberration may be uniformly distributed. With the effective focal length of the second lens group (G2) being positive and relatively small, the movement of the second lens group (G2) can effectively change the system focal length of the imaging zoom lens to increase the zoom magnification ratio of the imaging zoom lens. By virtue of the negative effective focal length (f3) of the third lens group (G3) cooperating with the distance between the second and third lens groups (G2, G3), the positive refractive powers of the first and second lens groups (G1, G2) can be effectively balanced, such that the aberration caused by the third lens group (G3) can be minimized.

2. In regard to each of the aforesaid seven embodiments of this disclosure, the longitudinal spherical, astigmatism and distortion aberrations are in compliance with applicable standards. The off-axis rays corresponding respectively to wavelengths of red, green and blue rays are converged around the imaging point. It is evident from the deviation range of each of the curves that deviations of the imaging points of the off-axis rays are well controlled so that the imaging zoom lens has good performance in terms of in spherical aberration, astigmatism aberration and distortion aberration. Furthermore, since the curves with different wavelengths that respectively represent red, green, and blue rays are close to each other, the imaging zoom lens has a relatively low chromatic aberration. As a result, by virtue of the abovementioned design of the lens groups (G1-G3), good imaging quality may be achieved.

3. Through the aforesaid seven embodiments, it is evident that the imaging zoom lens can be configured to have a relatively reduced overall thickness with good optical and imaging performance, and satisfy requirements of product miniaturization for the portable electronic devices.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An imaging zoom lens comprising a first lens group, a second lens group and a third lens group in sequence from an object side to an image side along an optical axis of said imaging zoom lens, wherein:
said first lens group has a positive effective focal length and an aperture stop;
said second lens group has a positive effective focal length;
said third lens group has a negative effective focal length; and
said imaging zoom lens satisfies:
1.31<f1/fw<2.87;
0.62<f2/fw<1.06;
0.45<|f3|/fw<1.00;
1.33<TTLw/ImagH<4.00; and
1.50<ft/fw<5.00,
where
f1 represents the effective focal length of said first lens group,
f2 represents the effective focal length of said second lens group,
f3 represents the effective focal length of said third lens group,
TTLw represents a total lens length of said imaging zoom lens at a wide angle end on the optical axis,
ImagH represents a maximum image height of said imaging zoom lens on an image plane of said imaging zoom lens,
ft represents a system focal length of said imaging zoom lens at a telephoto end, and
fw represents a system focal length of said imaging zoom lens at the wide angle end.

2. The imaging zoom lens as claimed in claim 1, wherein said first lens group includes three lens elements, said second lens group includes one lens element, and said third lens group includes one lens element.

3. The imaging zoom lens as claimed in claim 1, wherein said first lens group includes two lens elements, said second lens group includes one lens element, and said third lens group includes one lens element.

4. The imaging zoom lens as claimed in claim 1, wherein said first lens group includes four lens elements, said second lens group includes one lens element, and said third lens group includes one lens element.

5. The imaging zoom lens as claimed in claim 1, wherein said first lens group includes three lens elements, said second lens group includes three lens elements, and said third lens group includes one lens element.

6. The imaging zoom lens as claimed in claim 1, wherein said first lens group includes four lens elements, said second lens group includes two lens elements, and said third lens group includes one lens element.

7. The imaging zoom lens as claimed in claim 1, wherein said first lens group includes three lens elements, said second lens group includes two lens elements, and said third lens group includes one lens element.

8. The imaging zoom lens as claimed in claim 1, wherein said first lens group includes two lens elements, said second lens group includes two lens elements, and said third lens group includes one lens element.

9. An imaging zoom lens comprising a first lens group, a second lens group and a third lens group in sequence from an object side to an image side along an optical axis of said imaging zoom lens, wherein:
said first lens group has a positive effective focal length;
said second lens group has a positive effective focal length;
said third lens group has a negative effective focal length; and
said imaging zoom lens satisfies:
1.69<f1/fw<2.43;
0.69<f2/fw<0.98;
0.58<|f3|/fw<0.83;
1.71<TTLw/ImagH<2.14; and
2.30<ft/fw<3.00,
where
f1 represents the effective focal length of said first lens group,
f2 represents the effective focal length of said second lens group,
f3 represents the effective focal length of said third lens group,
TTLw represents a total lens length of said imaging zoom lens at a wide angle end on the optical axis,
ImagH represents a maximum image height of said imaging zoom lens on an image plane of said imaging zoom lens,
ft represents a system focal length of said imaging zoom lens at a telephoto end, and
fw represents a system focal length of said imaging zoom lens at the wide angle end.
